(19) United States
(12) Patent Application Publication
(10) Pub. No.: US 2006/0291352 A1
(43) Pub. Date: Dec. 28, 2006

(54) Optical disc recording control method and optical disc recording control apparatus

(76) Inventors: Kazuhiro Murakami, Kyoto (JP); Keita Takada, Shiga (JP); Yasutsugu Toyoda, Kyoto (JP); Tokuyuki Saijyo, Osaka (JP); Masaya Kuwahara, Hyogo (JP)

Correspondence Address: MCDERMOTT WILL & EMERY LLP, 600 13TH STREET, N.W., WASHINGTON, DC, 20005-3096, US

(21) Appl. No.: 11/472,369

(22) Filed: Jun. 22, 2006

(30) Foreign Application Priority Data
Jun. 22, 2005 (JP) 2005-181970
Jun. 9, 2006 (JP) 2006-161174

(51) Int. Cl. G11B 7/12

(52) U.S. Cl. 369/47.53

(57) ABSTRACT

Before data is recorded in an optical disc, an optimum recording power is calculated in an inner peripheral part and in an outer peripheral part of the optical disc based on OPC learning. Before the data is recorded in the optical disc, the optimum recording power is calculated in at least an intermediate part between the inner peripheral part and the outer peripheral part of the optical disc based on the OPC learning. Then, a correlation between position shift amounts in the inner peripheral part, the outer peripheral part and the intermediate part along a radial direction of the optical disc and the optimum recording powers calculated in the respective parts is calculated. The optimum recording power in a current recording part is set based on the correlation when the data is recorded, and laser drive control is executed with the set optimum recording power so that the data is recorded in the optical disc.

### BACKGROUND OF THE INVENTION

1. Field of the Invention

The present invention relates to a recording control method and a recording control apparatus relating to control of a writing operation to an optical disc capable of recording into a groove.

2. Description of the Related Art

Today, optical discs, such as CD (Compact Disc) and DVD (Digital Versatile Disc), are the mainstream of a recording medium in which video information, audio information and other information of various formats can be stored because it is possible to record at a high-density and have access to a desired data at a high speed in the optical disc.

A optical disc only for reproduction is provided with an uneven part, which is called a pit, on a track formed in a spiral shape or in a concentric shape on a substrate thereof. A laser light emitted from a laser diode is made to follow the track, a reflected light from the pit is detected by a photo diode, and information recorded on the optical disc is thereby read in accordance with an intensity of the reflected light.

Meanwhile, on an optical disc of RECORDING type, a recording layer is formed on a reflection layer. Examples of an optical disc capable of a groove recording are DVD-R, DVD+R, DVD-RW, DVD-RW, DVD+RW and the like.

Below is described a substrate structure and a recording/reading method of the optical disc of recording type referring to FIG. 24. FIG. 24 shows a part of the reflection layer and the recording layer of the substrate of the optical disc. 91 denotes a recording layer in which the information is not recorded, 92 denotes a recording layer in which the information is recorded, 93 denotes a reflection layer, 94 denotes an incident laser light, 95 denotes a reflected light of the laser light from the recording layer 91 in which the information is not recorded, and 96 denotes a reflected light of the laser light from the recording layer 92 in which the information is recorded. In the example shown in the drawing, the reflected light 96 passing through the recording layer 92 in which the information is recorded is reflected at a reflectivity higher than that of the reflected light 95 passing through the recording layer 91 in which the information is not recorded, a reason for which is described below.

The recording layer is formed on the reflection layer in the optical disc of recording type. The recording layer has such a property that a property thereof is changed by the irradiation of a high laser power, and the property is utilized so that the information is recorded on the optical disc. The change of the quality of the recording layer means the change of an absorptivity or a refractivity of the laser light. As the absorptivity of the laser light in the recording part is increased, the reflectivity of the optical disc is reduced at the time of reproduction. Further, a wavelength (phase) of the laser light transmitting through the recording part is changed at the time of the reproduction when the refractivity of the recording layer is changed. As a result, it substantially gives an effect as if the uneven part was formed in a reflective film. The information is written by changing the apparent reflectivity from the reflective film. If the laser light at the time of the reproduction has an output level equal to that of the recording operation, recording contents may be damaged every time when the information is read. Therefore, the laser light having an output level lower than that of the recording operation is used in the reproduction.

There are the disc only for recording once and the one for a rewritable use in the optical discs of recording type. In the disc only for recording once, an organic pigment of the azo-cyanine series is used in the recording layer. When the laser light which is a red visible light is irradiated on the pigment, the pigment absorbs the laser light well. Therefore, the reflectivity from the reflective film is apparently changed, and the information is thereby written. As the pigment material is chemically changed, the color is chanted and cannot be brought back to its original state, the information can be thus recorded only once. In the rewritable optical discs, such a technology as the phase change recording is used, wherein a property of an alloy formed from antimony and tellurium is utilized. To more specifically describe the property, in the case where the alloy is formed in such a thin-film shape that the light can transmit through it at a certain level, the alloy falls into the amorphous state when rapidly cooled down after the laser light having a strong power is irradiated thereon in a short period of time and it is heated to such a temperature to melt the alloy, and the alloy in the amorphous state returns to its original crystalline state when heated with a weak power.

The alloy is mixed with germanium so that the absorptivity of the laser light is made difference between in the amorphous state and in the crystalline state, and further, the alloy is mixed with silver and indium so that the refractivity is made difference between the two states. In other words, the information is recorded when the recording pit is formed through the heating at the melting point, while the information is erased when it is recrystallized. Because the described change is unlimitedly repeatable, the information is rewritable in the optical disc of recording type having the recording film mentioned above.

In the recording control to the optical disc using the laser light thus described, it is necessary to output an optimum recording laser power in order to accurately write the information. The optimum recording laser power is different in each optical disc because there is a sensitivity variation to the laser light in each optical disc recording medium. Further, the sensitivity comes under the influence of a temperature when the information is recorded. Therefore, it is necessary to obtain information of the optimum laser power by actually recording the information using the laser light in an appropriate manner.

The recording medium is requested to satisfy the demand of a higher density than in the conventional technology as a volume of the information to be handled increases. In order to satisfy the demand, various modifications have been made in the recording formats of the optical discs. An example of the modifications is a method for recording the information in a high density by narrowing a width of the track in the optical disc, or by narrowing a pitch of the track or the like. In such a recording method, a wobbling groove part (thin groove) and a wobbling land part are paired in the track formed on the substrate of the optical disc in order to improve an accuracy in reading an address information and an accuracy in controlling rotation of the optical disc. The land part is formed between the groove parts. The paired groove and land parts are formed in the spiral shape or in the concentric shape from an innermost periphery toward an outermost periphery of the disc. The recording method is disclosed in the Laid-Open Disclosure of the Japanese Patents (No. H10-293926 of the Publication of the Unexamined Japanese Patent Applications). Below is given a detailed description of the recording method.

FIG. 25 shows a recording format to the groove part and the land part according to the conventional technology. FIG. 26 shows a data structure in the optical disc. Groove parts 11 wobbled by a wobble signal having a predetermined frequency component to record the information and 1 and parts 12 provided between the adjacent groove parts 11 are formed in the spiral shape or in the concentric shape on the optical disc. Further, land pre-pits 13 having a predetermined phase relationship with respect to the wobble signal are formed in the land parts 12. The land pre-pit 13 denotes auxiliary information such as the address information for recording the data.

In the optical disc having the recording format shown in FIGS. 25 and 26, the groove parts 11 in which the data is recorded are previously divided into each sync frame as an information unit. Then, the sync frame constitutes a recording sector, and the recording sector constitutes an error correcting code. Provided that a unit length corresponding to a pit interval specified by the recording format when the data is recorded is T, one sync frame has the length of 1488T, and a part having the length of 14T in the head of one sync frame is used as a synchronous information 19 for synchronization of each sync frame.

The land pre-pit 3 is recorded for each sync frame. The land pre-pit 13 denoting a synchronous signal in a pre-information is formed on the land part adjacent to a region where the synchronous information in each sync frame is recorded. Further, one or two land pre-pits 13 may be formed in some cases in order to show contents of the pre-information to be recorded.

In the information recording to the optical disc having the foregoing recording format, a phase of a signal responsible for a phase of the wobble signal extracted from the groove part and a phase of a land pre-pit signal detected from the land pre-pit on the land part are compared to each other, and a phase difference signal is outputted based on a result of the comparison. Then, a phase of a clock signal is adjusted based on the phase difference signal. More specifically, a variation on an adjustment axis of the clock signal generated based on the wobble signal inevitably subjected to an influence from crosstalk is corrected with the land pre-pit free of any influence from the crosstalk. Therefore, the clock signal for the recording synchronizing with the rotation of the optical disc with a high precision can be generated, and the information can be thereby accurately recorded. In the DVD+R, DVD-R, DVD+RW and DVD-RW, the data is recorded through the irradiation of a laser light spot on the groove parts.

In the optical disc having the track on which the together wobbling groove and land parts are formed in the spiral shape or in the concentric shape thus described, it is necessary to determine the optimum recording laser power in order to record the data. When the optimum recording laser power is conventionally determined, a trial writing operation in which a recording peak power is changed is implemented in trial writing regions (PCA region: Power Calibration Area) present in the innermost and outermost peripheries of the optical disc prior to the actual data recording so that the recording laser power suitable for each disc is determined in each disc. This is hereinafter called OPC learning (OPC: Optimum Power Control). In the OPC learning, a test data is actually recorded (test recording) while the recording peak power is being changed in the innermost periphery of the disc, a signal of the recorded test data is read, and a beta value of the read RF signal (denoting an irregularity of a depth of the pit written in the optical disc by the laser light power) is measured. Thereby, a state of the regions of the recording disc are inspected, and the recording laser power which is the most suitable for the optical disc is determined based on a result of the inspection. Below is given a further detailed description of the OPC learning referring to FIGS. 27A-27C.

FIGS. 27A-27C each shows a method for determining the optimum recording power in the OPC learning. First, as shown in FIG. 27A, the test recording is performed while the peak power is changed stepwise, and the beta value of the optical disc is calculated based on the RF signal read from the written data. The beta value of the optical disc in the test recording having a random pattern can be calculated from an expression shown in FIG. 27B. In the expression, Peak denotes a peak of the RF signal obtained from the data written in the test recording, Bottom denotes a bottom value of the RF signal obtained from the data written in the test recording, and Ave denotes an average value of the RF signal obtained from the data written in the test recording. FIG. 27C is a graph showing a relationship between the laser power and the beta value. In the expression shown in FIG. 27B, the beta values corresponding to a few samples of the laser power are calculated, and the laser power when the beta value is 0 is determined as the optimum recording laser power.

The optimum recording laser power determined in the foregoing method is actually used in the CLV (Constant Linear Velocity) recording and the CAV (Constant Angular Velocity) recording in different manners. The CLV is a spindle control in which the optical disc is rotated at a constant linear velocity, while the CAV is a spindle control in which the optical disc is rotated at a constant rotational speed. In the CLV, a distance of passage on the optical disc per unit time is equal on the inner and outer peripheries of the optical disc because the linear velocity is constant, and therefore, the recording power is constant in the inner and outer peripheries. The CLV recording is generally adopted in the recording operation with respect to the DVD. In the CLV recording, the OPC learning is performed in the PCA regions of the optical disc, and the optimum recording power is determined. Then, the recording operation is executed with the same recording power from the inner periphery to the outer periphery of the optical disc. In the CAV recording, the passage distance per unit time (that is linear velocity) is different in the inner and outer peripheries because the rotational speed is constant. The optimum recording power is naturally increased toward the outer periphery because the linear velocity is gradually increased toward the outer periphery.

The conventional CAV recording is described here. FIGS. 28A-28B each illustrates the conventional calculation of the optimum recording power. FIG. 28A shows the place where the OPC is implemented in the conventional CAV recording. In the CAV recording, in general, the OPC learning is performed in the PCA region in the innermost periphery and the PCA region in the outermost periphery. Then, as shown in FIG. 28B, an optimum recording power table is calculated through linear approximation, and the recording operation is executed by sequentially changing the recording power based on the optimum recording power table.

FIG. 29 is a block diagram showing a constitution of an optical disc recording control apparatus for executing the recording control according to the conventional technology. A reference numeral 21 denotes an optical head. The optical head 21 includes a laser diode for emitting the laser light to an optical disc 20, a photo detector for detecting the laser light reflected from the optical disc 20, and an optical signal processing circuit having a pre-light photo detector for receiving a pre-light of the laser light. 22 denotes an RF signal detector for detecting an RF signal component from a signal generated in the optical signal processing circuit provided in the optical head 21. 23 denotes a beta value calculator for calculating a beta value representing an irregularity of a depth of a pit written in the optical disc 20 with the laser light power. 24 denotes an optimum power calculator for calculating the optimum laser power based on a calculation result of the beta value calculator 23 and a property of the optical disc. 25 denotes a memory in which an OPC learning address and an OPC learning result are stored. 50 denotes an inner and outer point linear interpolator for a two-point linear approximation of the OPC learning results in the inner and outer periphery. 27 denotes a laser drive device for controlling a drive current of the optical signal processing circuit provided in the optical head 21 based on a calculation result of the optimum power calculator 24. 30 denotes a focus and tracking servo unit which generates a focus signal and a tracking signal from a signal wherein a reflected light from the optical disc is detected and outputted by the photo detector of the optical signal processing circuit provided in the optical head 21, controls the optical signal processing circuit provided in the optical head 21 based on the focus and tracking signals, and executes a focus and tracking controls. 51 denotes a PCA position determining unit for determining positions in innermost and outermost peripheries where the OPC learning is performed. 28 denotes an optical head moving unit for moving the optical signal processing circuit.

Next, a conventional method for recording the information in the optical disc shown in FIG. 25 using the optical disc recording control apparatus shown in FIG. 29 is described referring to a flow chart of FIG. 30.

Prior to the data recording to the optical disc, the test recording is implemented (n10). First,in the OPC learning in the PCA region in the innermost peripheral part (n11), the test recording is performed so that the information is recorded in the optical disc in a state that the recording peak power is changed stepwise (n51). Then, the laser light is irradiated again on the part where the test recording was performed. The laser light reflected from the optical disc is received by the photo detector, and the received reflected light is converted into an electrical signal. Then, the RF component is extracted from the electrical signal in the RF signal detector 22 (n52). Based on the extracted RF component, a depth of a pit 18 written in the optical disc and the like, are detected by the beta value calculator 23. Then, a relationship between the recording power and the property of the optical disc medium is calculated so that the beta value is obtained (n53). In the optimum power calculator 24, the recording power suitable for the recording with respect to the optical disc during the test is calculated based on the beta value calculated by the beta value calculator 23 (n54). When the optimum recording power in the innermost peripheral part is determined, the optical head moving unit 28 is controlled, and the laser light spot thereby moves to the PCA region in the outermost peripheral part. Then, the OPC learning is performed there again and the relevant optimum recording power is calculated (n12). At the time, the OPC learning addresses and the calculated optimum powers are memorized in the memory 25.

Next, the optimum recording power in a current recording part is determined (n13). The respective OPC learning addresses calculated in the previous step and the optimum recording powers in the relevant sites are read from the memory 25 (n101). Based on the read data, the learning result in the innermost peripheral part and the learning result in the outermost peripheral:part are treated by the two-point linear approximation so that the optimum recording power in the current recording part is calculated (n102). Finally, the CAV recording is initiated based on the calculated optimum recording power in the current recording part (n14)

A high speed recording has been advancing in the recording control with respect to the optical disc these days, and the high-speed CAV recording is the mainstream in the field of the optical disc recording. However, the optimum recording power in an intermediate part in a radial direction of the optical disc is calculated based on the OPC learning results in the innermost and outermost peripheral parts alone in the conventional method. Therefore, the optimum recording power in the intermediate part in a radial direction of the disc shifts from a desired value if there is a variation in the property of the optical disc surface so as to deteriorate a recording quality. Disadvantages is generated, for example, that a wrong address may be obtained due to deterioration of a PI error rate, or compatibility with drives made by the other companies may be deteriorated. In recent years, the problem has been getting more acute because a large number of the optical discs with a poor quality such as an excessive sensitivity, a large film thickness and a large distortion in surfaces thereof have been commercialized in the market of the optical discs.

### SUMMARY OF THE INVENTION

Therefore, a main object of the present invention is to realize a high-quality recording by using an optimum recording laser power suitable for a property of an optical disc.

In the present invention, the OPC learning is sequentially implemented in an intermediate part in a radial direction of the optical disc so that an optimum recording laser power schedule from an inner peripheral part to an outer peripheral part of the optical disc in the CAV recording is determined.

An optical disc recording control method according to the present invention comprises,

a step for calculating an optimum recording power based on OPC (Optimum Power Control) learning in an inner peripheral part and an outer peripheral part of an optical disc, and at least one of the intermediate parts between the inner and outer peripheral before data is recorded in the optical disc, and

a step for setting the optimum recording power in a current recording part based on a correlation between position shift amounts along a radial direction of the optical disc in the inner peripheral, outer peripheral and intermediate parts and the optimum recording powers calculated in the respective parts, and recording the data in the optical disc by executing laser drive control using the set optimum recording power.

It is preferable that the optical disc has a track, which has a groove part and a land part, and the optimum recording power in the land part is calculated in the intermediate part.

The groove part is a region provided essentially for an information to be recorded in a disc region (data region) in the intermediate part sandwiched between the inner peripheral part (PCA region) and the outer peripheral part (PCA region) of the optical disc. On the other hand, the land part is a region having an auxiliary information such as an address information for recording the data. In the present invention, the OPC learning is implemented, not only in the inner and outer peripheral parts, but also in the intermediate part (preferably, land part) as the data region. As a result, the data can be recorded with the optimum laser power suitable for the property of the optical disc, so that the CAV recording with a high quality is realized. The OPC learning in the intermediate part is preferably implemented in the land part. Therefore, it can be applied to a R-system DVD in which the data can only be written once due to the physical property having an organic pigment.

There is an embodiment in the foregoing recording control method, wherein, before the OPC learning is performed in at least one region of the inner peripheral, outer peripheral and intermediate parts of the optical disc, it is detected whether or not any surface defect, such as fingerprint or scratch, is present in the part of the optical disc where the OPC learning is performed so that an optical head is moved to any position with no surface defect. In this case, as the OPC learning can be selectively implemented at the region with no surface defect such as fingerprint or scratch, the OPC learning can be performed at high accuracy, or prevents the OPC learning from failing. As a result, the optimum recording power can be more accurately determined, which assures a high quality recording.

An optical disc recording control apparatus according to the present invention comprises,

an optical head for recording data in an optical disc,

an OPC learning address determining unit for determining a position in a radial direction of a disc in an inner peripheral part of the optical disc, a position in a radial direction of a disc in an outer peripheral part of the optical disc, and a position in a radial direction of a disc in at least one of the intermediate parts between the inner and outer peripheral parts where OPC (Optimum Power Control) learning is to be implemented prior to the data recording to the optical disc,

an optical head moving unit for moving the optical head to the respective inner peripheral, outer peripheral and intermediate parts, whose positions in a radial direction of a disc are determined by the OPC learning address determining unit,

an optimum power calculator for calculating an optimum recording power in the inner peripheral, outer peripheral and intermediate parts from an information representing an irregularity of a property of the optical disc included in a laser light which is emitted from the optical head moved to the respective inner peripheral, outer peripheral and intermediate parts and thereafter reflected from the optical disc,

a memory for memorizing a correlation between position shift amounts along a radial direction of the optical disc in the inner peripheral, outer peripheral and intermediate parts determined by the OPC learning address determining unit and the optimum recording powers in the respective parts calculated by the optimum power calculator,

a recording power controller for setting the optimum recording power in a current recording part of the optical disc based on the correlation read from the memory when the data is recorded, and

a laser drive device for recording the data in the optical disc via the optical head while controlling the optimum recording power in the current recording part of the optical disc by the set value of the recording power controller when the data is recorded.

According to this structure, the correlation between the parts of the disc where the OPC was implemented (address) and the optimum recording powers is memorized in the memory before the data is recorded. The OPC learning is not necessarily performed in the order of the inner peripheral part→intermediate part→outer peripheral part, but it may be done in any arbitrary order. When the data is recorded, the recording power controller sets the optimum recording power in the current recording part based on the correlation memorized in the memory, and controls the laser drive device by the set value, so that the data is recorded. As a result, the data can be recorded with the optimum laser power suitable for the property of the optical disc, and the CAV recording in a high quality is realized.

The optical disc recording control apparatus preferably further comprises,

an RF signal detector for detecting an RF signal included in a detected signal of the laser light, and

a beta value calculator for measuring a beta value representing the irregularity of the property of the optical disc from the RF signal detected by the RF signal detector, wherein

the optimum power calculator handles the beta value measured by the beta value calculator as the information representing the irregularity of the property of the optical disc.

Accordingly, the optimum power calculator sets the optimum recording power in the part where the OPC learning is performed based on the beta value (representing an irregularity of an intensity in recording the data in the optical disc using the laser light).

The optical disc recording control apparatus preferably further comprises a groove recording power corrector, wherein the groove recording power corrector corrects the optimum recording power in the land part of the intermediate part calculated by the optimum power calculator into the optimum recording power in the groove part of the intermediate part.

A purpose of a test recording in the intermediate part (land part) is to calculate the optimum recording power when the data is recorded in the groove part. It is unnecessary to correct the optimum recording power when the recording in the land part and the recording in the groove part are equivalent to each other. However, there may be an error in some cases between the optimum recording power obtained in the test recording in the land part and the optimum recording power when the data is recorded in the groove part due to a difference in shapes of the land and groove parts. Therefore, the groove recording power corrector is provided so that the optimum recording power calculated in the OPC learning in the land part is corrected so as to be able to improve a setting accuracy of the optimum recording power.

The optical disc recording control apparatus further comprises a land/groove corrector, wherein the land/groove corrector preferably corrects so as to eliminate any influence, which is given to the groove part adjacent to the relevant land part by the laser light irradiated in order to obtain the optimum recording power in the land part, from the optimum recording power in the land part of the intermediate part calculated by the optimum power calculator.

When the OPC learning is performed in the land part, the groove part adjacent to the land part is inevitably thereby affected in no small measure. Therefore, the optimum recording power calculated by the optimum power calculator is corrected so that the influence given to the groove part by the OPC learning in the land part is eliminated by the land/groove corrector. Thereby, the optimum recording power can be set at a higher accuracy.

The optical disc recording control apparatus preferably further comprises,

an RF signal level anomaly detector for detecting whether or not any anomaly is generated in a level of the RF signal detected by the RF signal detector when the optimum power calculator calculates the optimum power, and

a land part learning address corrector for correcting the position in radial direction of a disc in which the anomaly is detected when the RF signal level anomaly detector detects the anomaly, wherein it is preferable that

the optical head moving unit moves the optical head to the position in radial direction of a disc corrected by the land part learning address corrector, and

the optimum power calculator recalculates the optimum recording power in each of the positions in radial direction of a disc from the information representing the irregularity of the property of the optical disc included in the laser light emitted from the optical head moved to the corrected position in radial direction of a disc and thereafter reflected from the optical disc.

The level of the RF signal may show the anomaly due to the presence of the surface defect, such as fingerprint or scratch in the intermediate part where the OPC learning is performed. In such a case, the position (address) of the part where the OPC learning is performed is corrected, and the OPC learning is performed again, so that the optimum recording power can be determined at a much higher accuracy so as to achieve the recording at a higher quality.

The optical disc recording control apparatus preferably further comprises,

a beta value anomaly detector for detecting whether or not the beta value calculated by the beta value calculator shows any anomaly when the optimum power calculator calculates the optimum power, and

a land part learning address corrector for correcting the position in radial direction of a disc where the anomaly is detected when the beta value anomaly detector detects the anomaly, wherein

the optical head moving unit moves the optical head to the position in radial direction of a disc which is corrected by the land part learning address corrector, and

the optimum power calculator recalculates the optimum recording power in each of the positions in radial direction of a disc from the information representing the irregularity of the property of the optical disc included in the laser light which is emitted from the optical head moved to the corrected position in radial direction of a disc and thereafter reflected from the optical disc.

The beta value may show the anomaly due to the presence of the surface defect, such as fingerprint or scratch, in the intermediate part where the OPC learning is performed. In such a case, the OPC learning address is corrected, and the OPC learning is performed again, so that the optimum recording power can be determined at a much higher accuracy so as to achieve the recording at a higher quality.

The recording power controller preferably treats the correlation through a linear interpolation to thereby set the optimum recording power in the current recording part or processes the correlation by means of the least squares method so that the optimum recording power in the current recording part is set. In particular, the OPC learning result in each land part is processed by means of the least squares method so that the inner and outer peripheries are linearly interpolated as a simple expression of P (x)=Ax+B. As a result, a processing burden in firmware can be reduced when the optimum recording power table is generated, and the recording at a higher speed is realized.

The optical disc recording control apparatus further comprises an error monitor for interrupting the recording when any error raised the recording interruption is generated when the data is recorded, wherein it is preferable that

the optical head moving unit moves the optical head to the position in radial direction of a disc where the error is generated,

the optimum power calculator calculates the optimum recording power in the position in radial direction of a disc where the error is generated from the information representing the irregularity of the property of the optical disc included in the laser light which is emitted from the optical head moved to the position in radial direction of a disc in which the error is generated and thereafter reflected from the optical disc, and

the memory memorizes the correlation to which the optimum recording power in the position in radial direction of a disc where the error is generated, calculated by the optimum power calculator, is added. As a result, the recording quality can be much more improved.

The optical disc recording control apparatus further comprises an additional recording position detector for detecting the position in radial direction of a disc of an additional recording position when the data is additionally recorded in the optical disc, wherein it is preferable that

the optical head moving unit moves the optical head to the additional recording position whose position in radial direction of a disc is detected by the additional recording position detector,

the optimum power calculator calculates the optimum recording power at the additional recording position from the information representing the irregularity of the property of the optical disc included in the laser light which is emitted from the optical head moved to the additional recording position and thereafter reflected from the optical disc, and

the memory memorizes the correlation to which the optimum recording power in the additional recording position calculated by the optimum power calculator is added.

By doing this, the OPC learning in the land part is performed from the additional recording position prior to the additional recording with respect to the optical disc, thereby, a time length for the OPC learning can be reduced, the optimum recording power is determined at a higher accuracy, and the additional recording can be achieved at a high quality.

The optical disc recording control apparatus further comprises a defect detector for detecting whether or not the surface defect is present in the inner peripheral part, outer peripheral part or intermediate part prior to the calculation of the optimum recording power based on the OPC learning in the inner peripheral, outer peripheral and intermediate parts, wherein it is preferable that

the OPC address determining unit changes the position in radial direction of a disc of the inner peripheral part, the position in radial direction of a disc of the outer peripheral or the position in radial direction of a disc of the intermediate part where the surface defect is detected to a position where the surface defect is not present when the defect detector defects the surface defect.

By doing this, the part where the OPC learning is implemented is checked whether or not the surface defect, such as fingerprint or scratch, is present prior to the implementation of the OPC learning so that the optical head is moved to the part with no surface defect so as to perform the OPC learning therein. Thereby, the OPC learning can be implemented at a higher accuracy or the OPC learning can be prevented from failing. As a result, the optimum recording power can be more accurately determined at a much higher accuracy, and the recording operation can be achieved at a high quality.

In the present invention, the test recording is sequentially implemented in at least one of the intermediate parts between the inner peripheral part and the outer peripheral part so that the optimum recording power of the optical disc is determined. As a result, the recording operation can be executed with the optimum recording power suitable for the property of the optical disc, and the recording can be done at a high quality.

When the test recording is performed, not in the groove part prepared for the information to be essentially recorded, but in the land part having the auxiliary information such as the address information, the data can be smoothly recorded without any trouble.

The optical disc recording control apparatus according to the present invention is effectively used for a control operation in which it is necessary to obtain a property of a laser diode or a property of an optical disc in an optical disc recording control apparatus corresponding to a high-speed recording.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 is a perspective view of a partial structure on a substrate of an optical disc recording medium according to a preferred embodiment 1 of the present invention.

FIG. 2 is a block diagram illustrating a constitution of an optical disc recording control apparatus according to the preferred embodiment 1.

FIG. 3 is a flow chart showing an operation of the optical disc recording control apparatus according to the preferred embodiment 1.

FIG. 4A is an illustration of calculation of an optimum recording power at a current address according to the preferred embodiment 1.

FIG. 4B is an illustration of the calculation of the optimum recording power at the current address according to the preferred embodiment 1.

FIG. 5 is a block diagram illustrating a constitution of an optical disc recording control apparatus according to a preferred embodiment 2 of the present invention.

FIG. 6 is a flow chart showing an operation of the optical disc recording control apparatus according to the preferred embodiment 2.

FIG. 7 is a block diagram illustrating a constitution of an optical disc recording control apparatus according to a preferred embodiment 3 of the present invention.

FIG. 8 is a flow chart showing an operation of the optical disc recording control apparatus according to the preferred embodiment 3.

FIG. 9 is a block diagram illustrating a constitution of an optical disc recording control apparatus according to a preferred embodiment 4 of the present invention.

FIG. 10 is a flow chart showing an operation of the optical disc recording control apparatus according to the preferred embodiment 4.

FIG. 11 is a block diagram illustrating a constitution of an optical disc recording control apparatus according to a preferred embodiment 5 of the present invention.

FIG. 12 is a flow chart showing an operation of the optical disc recording control apparatus according to the preferred embodiment 5.

FIG. 13 is a block diagram illustrating a constitution of an optical disc recording control apparatus according to a preferred embodiment 6 of the present invention.

FIG. 14 is a flow chart showing an operation of the optical disc recording control apparatus according to the preferred embodiment 6.

FIG. 15A is an illustration of calculation of an optimum recording power at a current address according to the preferred embodiment 6.

FIG. 15B is an illustration of the calculation of the optimum recording power at the current address according to the preferred embodiment 6.

FIG. 16 is a block diagram illustrating a constitution of an optical disc recording control apparatus according to a preferred embodiment 7 of the present invention.

FIG. 17 is a flow chart showing an operation of the optical disc recording control apparatus according to the preferred embodiment 7.

FIG. 18 is a block diagram illustrating a constitution of an optical disc recording control apparatus according to a preferred embodiment 8 of the present invention.

FIG. 19 is a flow chart showing an operation of the optical disc recording control apparatus according to the preferred embodiment 8.

FIG. 20 is a block diagram illustrating a constitution of an optical disc recording control apparatus according to a preferred embodiment 9 of the present invention.

FIG. 21 is a block diagram illustrating a constitution of an optical disc recording control apparatus according to a preferred embodiment 10 of the present invention.

FIG. 22 is a flow chart showing an operation of the optical disc recording control apparatus according to the preferred embodiment 10.

FIG. 23 is a flow chart showing the operation of the optical disc recording control apparatus according to the preferred embodiment 10.

FIG. 24 is a sectional view of an optical disc of recording type.

FIG. 25 is a perspective view of a surface of the optical disc of recording type.

FIG. 26 shows a data structure in the optical disc of recording type.

FIG. 27A is an illustration of calculation of an optimum recording power in OPC learning.

FIG. 27B is an illustration of the calculation of the optimum recording power in the OPC learning.

FIG. 27C is an illustration of the calculation of the optimum recording power in the OPC learning.

FIG. 28A is an illustration of calculation of an optimum recording power at a current address according to a conventional technology.

FIG. 28B is an illustration of the calculation of the optimum recording power at the current address according to the conventional technology.

FIG. 28C is an illustration of the calculation of the optimum recording power at the current address according to the conventional technology.

FIG. 29 is a block diagram illustrating a constitution of an optical disc recording control apparatus according to the conventional technology.

FIG. 30 is a flow chart showing an operation of the optical disc recording control apparatus according to the conventional technology.

### DETAILED DESCRIPTION OF THE INVENTION

Hereinafter, preferred embodiments of the present invention are described referring to the drawings.

Preferred Embodiment 1

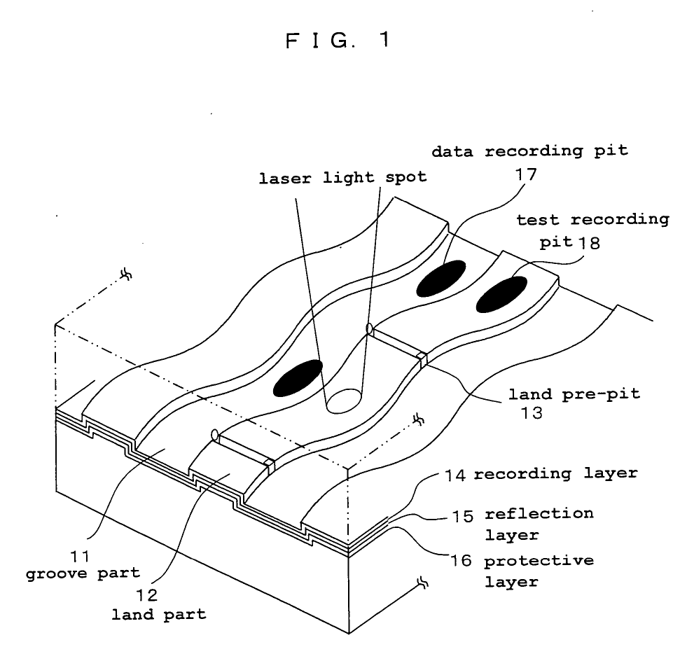

FIG. 1 is a perspective view of a partial structure on a substrate of an optical disc recording medium according to a preferred embodiment 1 of the present invention. In FIG. 1, a reference numeral 11 denotes a groove part formed on the optical disc in a spiral or a concentric shape. The groove part 11 is wobbling (meandering). A reference numeral 12 denotes a land part sandwiched between the groove parts 11. A reference numeral 13 denotes a land pre-pit which represents an auxiliary information such as an address information, for recording data. The land pre-pit 13 has a predetermined phase relationship relative to a wobble signal. The land pre-pit 13 is provided in the land part 12. A reference numeral 14 denotes a recording layer whose light absorptivity or refractivity is changed by a laser light outputting a recording laser power. A reference numeral 15 denotes a reflection layer for reflecting the laser light emitted to the optical disc. A reference numeral 16 denotes a protective layer provided for heat resistance and abrasion resistance. A reference numeral 17 denotes a data recording pit showing the data to be written in the groove part 11 when the recording operation is executed. A reference numeral 18 denotes a test recording pit showing test recording in OPC learning. The protective layer 16 is principally required to satisfy such properties as heat resistance, abrasion resistance, adhesion and strength. Therefore, resin superior in strength such as thermosetting resin, ultraviolet curing resin or electron radiation curing resin is used as a main constituent of the protective layer 16, and a lubricating agent is preferably also included therein in addition.

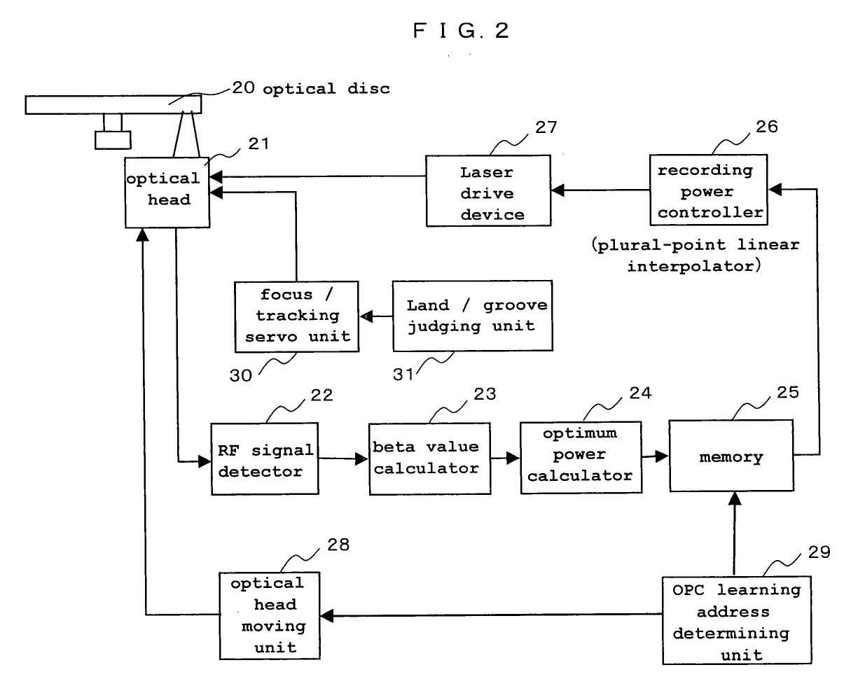

FIG. 2 is a block diagram illustrating a constitution of an optical disc recording control apparatus according to the preferred embodiment 1. In the drawing, a reference numeral 21 denotes an optical head. The optical head 21 includes an optical signal processing circuit. The optical signal processing circuit has a laser diode for emitting the laser light to the optical disc, a photo detector for detecting the laser light reflected from the optical disc, and a pre-light photo detector for receiving a pre-light of the laser light. A reference numeral 22 denotes an RF signal detector for detecting an RF signal component from a signal generated from a reflected light received by the optical head 21. A reference numeral 23 denotes a beta value calculator for calculating a beta value. The beta value represents an irregularity of a depth of a pit written in the optical disc by a power of the laser light. A reference numeral 24 denotes an optimum power calculator for calculating an optimum laser power for a property of the optical disc based on a result of the calculation by the beta value calculator 23. A reference numeral 25 denotes a memory in which an OPC learning address and an OPC learning result are stored. A reference numeral 26, which is an example of a recording power controller, denotes a recording power controller (plural-point linear interpolator) for calculating the optimum recording power at a current address by executing the plural-point linear interpolation which approximates a plurality of OPC learning results. A reference numeral 27 denotes a laser drive device for controlling a drive current of the optical signal processing circuit provided in the optical head 21 based on the optimum recording power from the recording power controller 26. A reference numeral 30 denotes a focus/tracking servo unit for generating a focus signal and a tracking signals and executing focus control and tracking control by controlling the optical signal processing circuit in the optical head 21 based on the generated signals. The focus signal and the tracking signal are generated by the focus/tracking servo unit 30 based on a signal which the photo detector in the optical head 21 outputs by detecting a reflected light from the optical disc. A reference numeral 31 denotes a land/groove judging unit for judging whether or not a region where a light spot is currently located is the land part or the groove part. A reference numeral 29 denotes an OPC learning address determining unit for determining a position where the OPC learning is performed in an innermost peripheral part and an outermost peripheral part, and at least one of the intermediate parts between the innermost peripheral part and the outermost peripheral part in the optical disc 20. A reference numeral 28 denotes an optical head moving unit for moving the optical head 21.

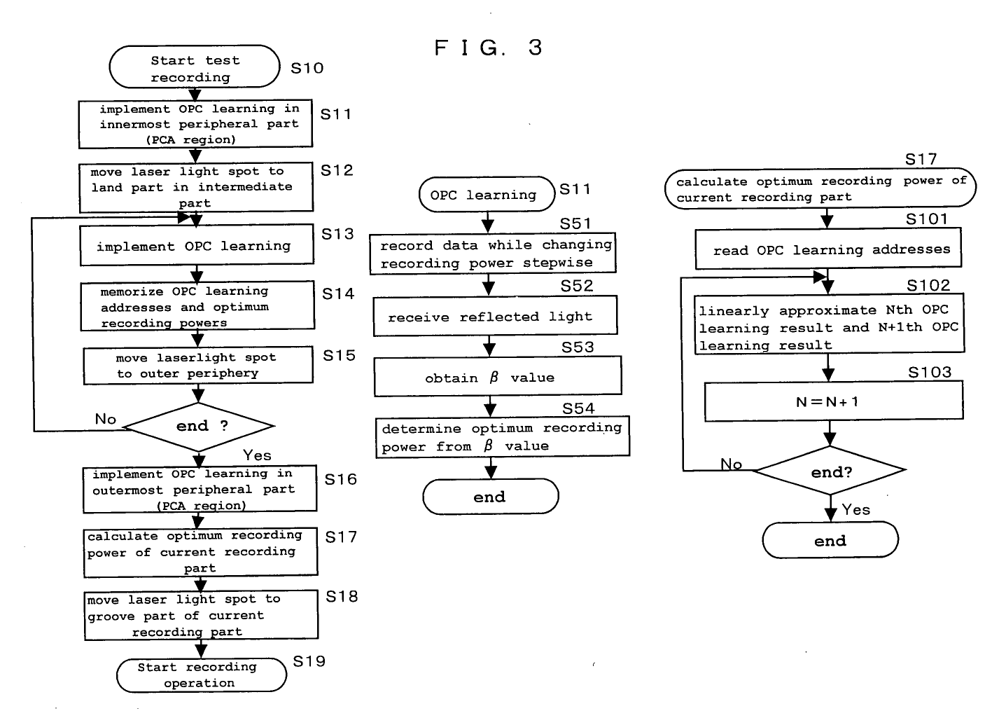

Below is described in detail an operation of the optical disc recording control apparatus according to the present preferred embodiment referring to a flow chart shown in FIG. 3. Prior to the data recording with respect to the optical discb having the structure shown in FIG. 1, first, the OPC learning is performed in the groove part 11 of a PCA region in the innermost peripheral part (S11). In the OPC learning in S11, a test recording is implemented wherein the data is recorded in the optical disc under the circumstances that the recording peak power is changed stepwise (S51). Thereafter, back to the region where the test recording was implemented, the laser light reflected from the optical disc is received by the photo detector, the received reflected light is converted into an electrical signal, and the RF component is extracted from the electrical signal by the RF signal detector 22 (S52). The beta value calculator 23 detects a depth and the like of the test recording pit 18 written in the optical disc based on the extracted RF component to thereby calculate a relationship between the recording power and the property of the optical disc medium so that the beta value is obtained (S53). The optimum power calculator 24 calculates the optimum recording power suitable for the recording with respect to the optical disc in the test based on the beta value obtained by the beta value calculator 23 (S54). The OPC learning result (the optimum recording power) and the OPC learning address (position shift amount in a radial direction of the disc) in the innermost peripheral part are memorized in the memory 25 in a state where they correspond to each other.

When the optimum recording power in the innermost peripheral part is determined, the optical signal processing circuit in the optical head 21 is controlled so as to make the laser light spot move to the land part 12 in the intermediate part as the data region (S12). The OPC learning is implemented again in the land part 12 in the intermediate part so that the optimum recording power is calculated (S13). When the OPC learning is completed, the OPC learning address (position shift amount in the radial direction of the disc) in the intermediate part and the optimum recording power calculated in the relevant part are memorized in the memory 25 in a state that they correspond to each other (S14). The optical signal processing circuit in the optical head 21 is controlled in the current state, and the OPC learning and the resulting recording operation are implemented once or a plurality of times while the laser light spot is moved to the outer peripheral side of the optical disc and until it reaches the outermost peripheral part (S15). When the laser light spot reaches the outermost peripheral part, the OPC learning is performed in the PCA region (groove part 11) in the outermost peripheral part (S16). The OPC learning address in the outermost peripheral part (position shift amount in the radial direction of the disc) and the OPC learning result calculated in the relevant part are memorized in the memory 25 in a state that they correspond to each other.

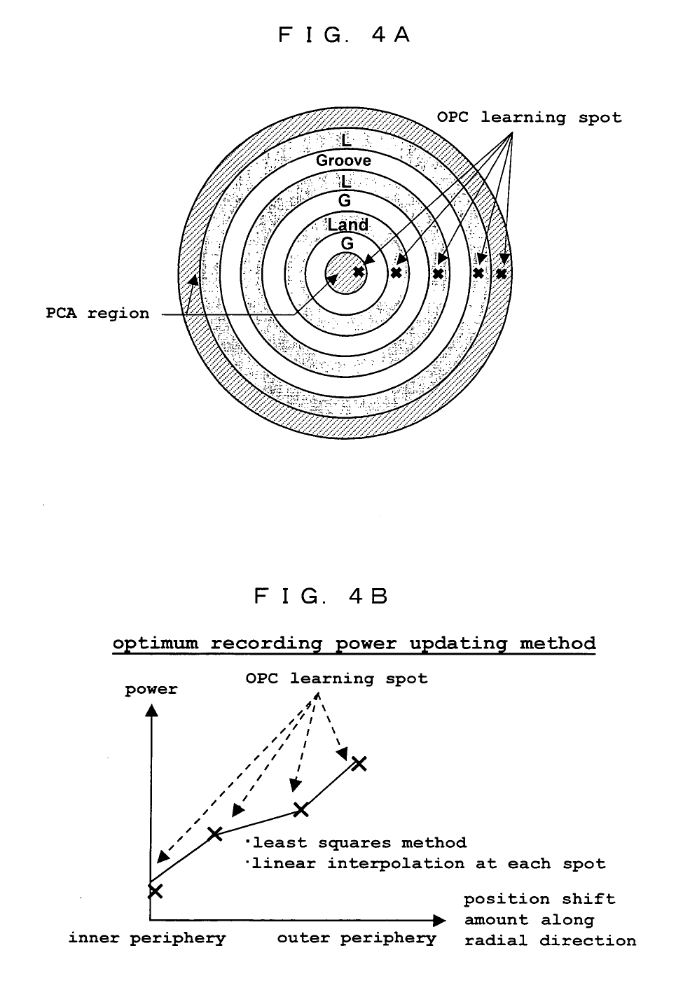

After the foregoing OPC learning operations are thus performed, the data is recorded. In recording the data, first, the optimum recording power in the current recording part is calculated (S17). When the optimum recording power in the current recording part is determined, the OPC learning results (optimum recording powers) and the OPC learning addresses (position shift amounts in the radial direction of the disc) calculated in the earlier step are read from the memory 25 (S101), and each of the OPC learning results in the adjacent regions where the OPC learning was implemented are treated by a two-point linear approximation so that the optimum recording power in the current recording part is calculated (S102 and S103). FIGS. 4A and 4B are illustrations of the calculation of the optimum recording power. FIG. 4A shows where the OPC learning is performed in the CAV recording. The OPC learning is performed in the innermost peripheral, outermost peripheral and intermediate parts, and an optimum recording power table is calculated through the two-point linear approximation in each zone as shown in FIG. 4B.

Finally, the optical head 21 moves to the groove part 12 (S18), and the CAV recording starts based on the calculated optimum recording power in the current recording part(S19).

In the present preferred embodiment, it is desirable that number of times of the OPC learning in the intermediate part is basically implemented more often as the property of the optical disc is more inferior. Then, the optimum recording power in the current recording part can be accurately obtained in compliance with variations of sensitivity and film thickness in the surface. Meanwhile, when the OPC learning is repeated in the intermediate part (land part 12) many times, it takes much time before the recording starts. In order to deal with the problem, it is preferable to set how many times the OPC learning should be performed in accordance with the property of the optical disc. The number of the OPC learning operations in accordance with the property of the optical disc can be experimentally calculated.

According to the present preferred embodiment, the OPC learning is repeatedly implemented in the intermediate part (in particular, land part 12 thereof) prior to the data recording, and the ultimate optimum recording power is then determined, so that the CAV recording can be achieved at a high quality.

Preferred Embodiment 2

In a preferred embodiment 2 of the present invention, a difference in the optimum recording powers due to a different shapes of the land and groove parts is corrected. The data is recorded in the groove part 11, and the test recording is implemented in the intermediate part (more specifically, land part 12 thereof) in order to calculate the optimum recording power for the data recording in the groove part 11. The correction is unnecessary if the recording in the land part 12 in the intermediate part and the recording in the groove part 11 are equivalent to each other. However, because of the actually different shapes of the land part 12 and the groove part 11, the optimum recording power obtained in the test recording in the land part 12 is desirably corrected when the data is recorded in the groove part 11. The preferred embodiment 2 corresponds to it. Hereinafter, an optical disc recording control apparatus according to the preferred embodiment 2 is described.

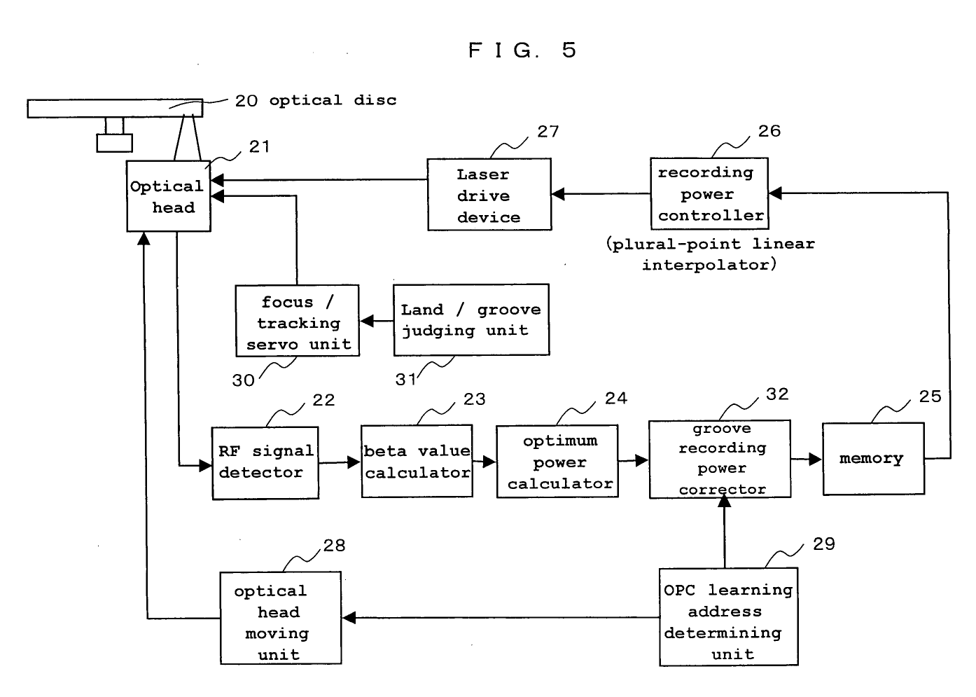

FIG. 5 is a block diagram illustrating a constitution of the optical disc recording control apparatus according to the preferred embodiment 2. In FIG. 5, a reference numeral 32 denotes a groove recording power corrector for correcting the optimum recording power in the land part 12 calculated by the optimum power calculator 24 into the optimum recording power suitable for the groove part 11 and outputting the corrected power to the memory 25. The rest of the components are the same as those shown in FIG. 2 according to the preferred embodiment 1. The same components are simply provided with the same reference numerals and not described in detail again.

The land part 12 and the groove part 11 are respectively a protruding part and a recessed part, and they are different in the shapes in the parts where the light spot is irradiated. Accordingly, the optimum recording powers respectively suitable for the land part 12 and the groove part 11 are different to each other. Therefore, the optimum recording power calculated through the OPC learning in the intermediate part (land part 12), which was described in the preferred embodiment 1, is corrected by the groove recording power corrector 32 and changed into the optimum recording power in the groove part 11 of the intermediate part. Thereby, the data can be recorded at a high quality.

The optimum recording power suitable for the groove part 11 is calculated in such a manner that the optimum recording power in the groove part 11 is multiplied by a coefficient k as shown in the following expression.
[optimum recording power in groove part]=k*[optimum recording power in land part]

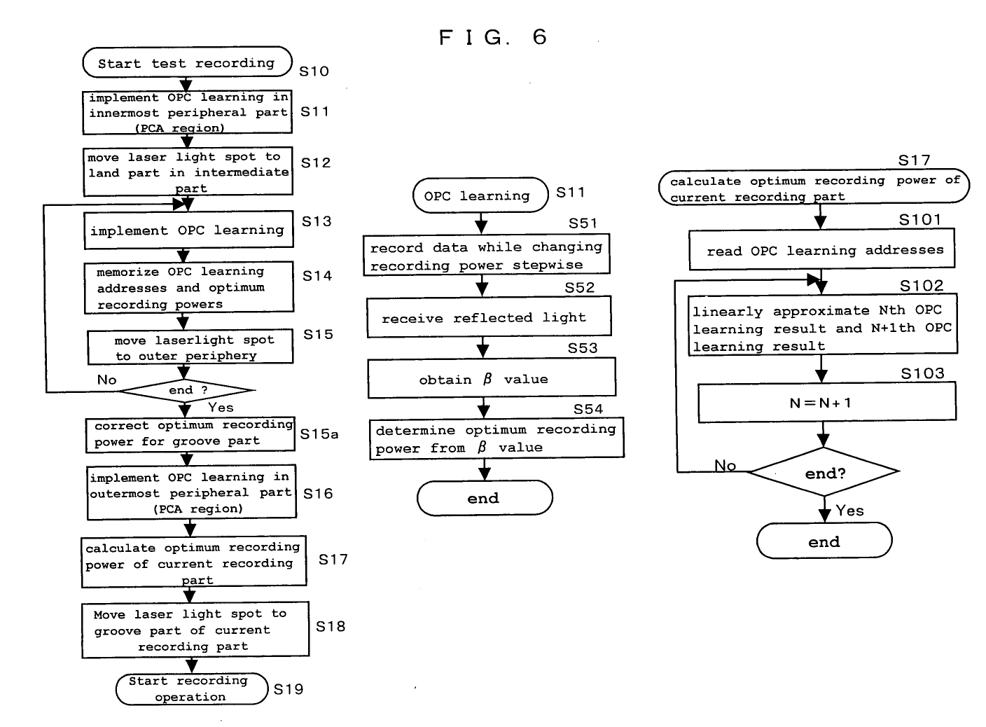

An operation of the optical disc recording control apparatus according to the present preferred embodiment is described referring to a flow chart shown in FIG. 6. The operation is the same as described in the preferred embodiment 1 up to determination for termination next to the step S15. A step S15a is inserted immediately before the step S16. In the step S15a, the optimum recording power in the intermediate part (land part 12) calculated in the earlier step is multiplied by the coefficient k so that the optimum recording power is corrected. As a result, the optimum recording power in the intermediate part (groove part 11) is determined.

Preferred Embodiment 3

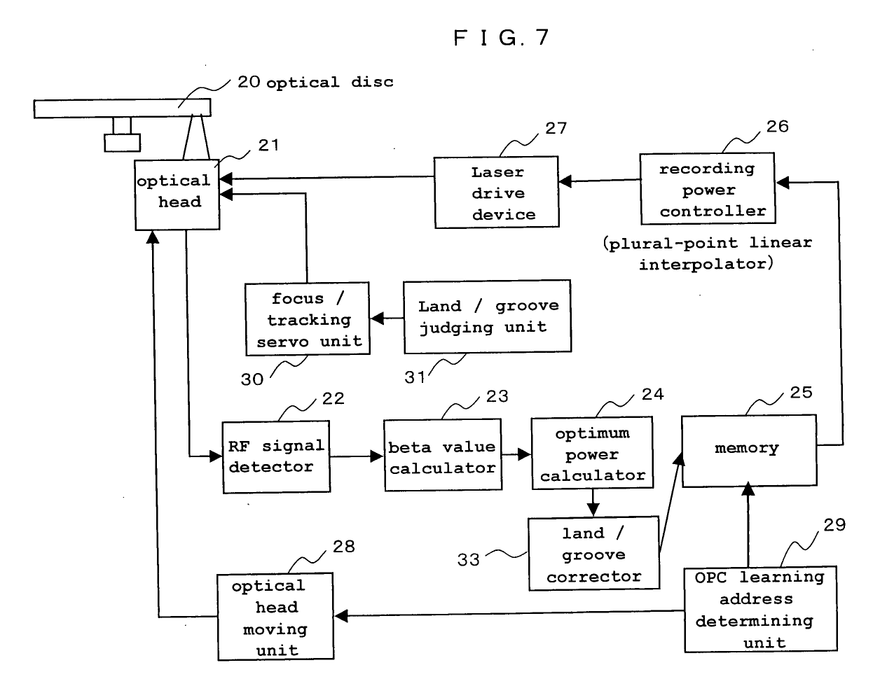

FIG. 7 is a block diagram illustrating a constitution of an optical disc recording control apparatus according to a preferred embodiment 3 of the present invention. In FIG. 7, a reference numeral 33 denotes a land/groove corrector for correcting the value of the optimum power calculator 24 in terms of an influence due to the data recording in the land part. The rest of the components are the same as those described in the preferred embodiment 1 (FIG. 2). The same components are simply provided with the same reference numerals and not described in detail again.

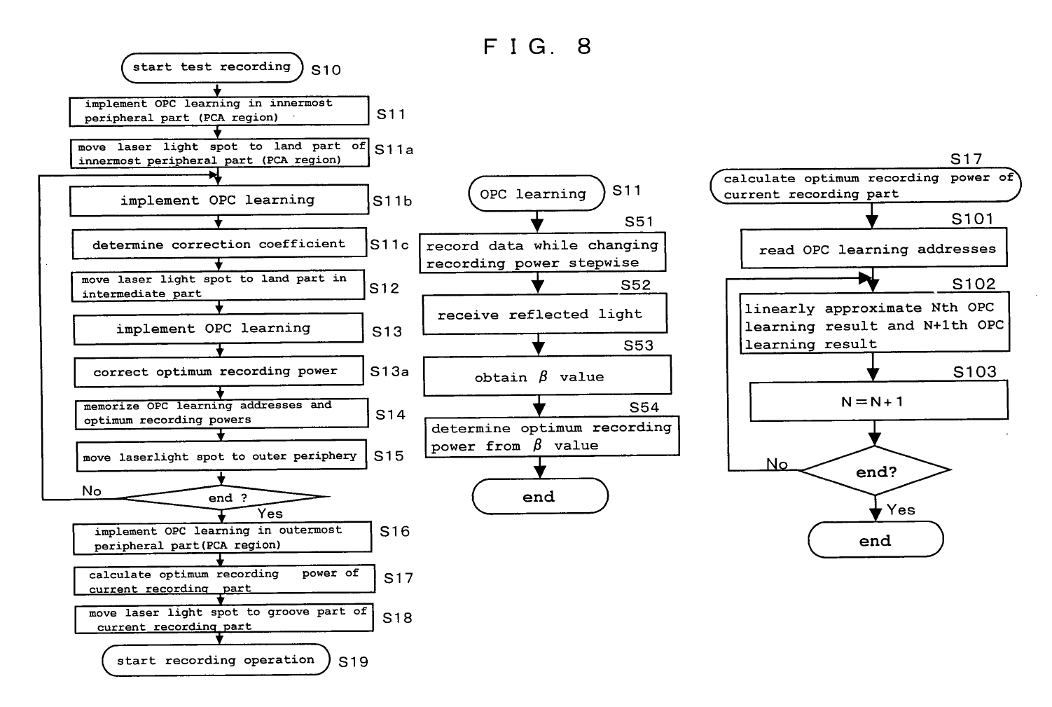

Below is specifically described an operation of the optical disc recording control apparatus according to the present preferred embodiment referring to a flow chart shown in FIG. 8.

Before the data is recorded in the optical disc, first, the OPC learning is performed in the groove part 11 of a PCA region in the innermost peripheral part (S11). Further, the OPC learning is performed in the land part 12 of another PCA region in the innermost peripheral part (S11a and S11b). The correction coefficient is determined from the OPC learning results in the land part 12 and in the groove part 11 (S11c).

Next, steps S12 and S13, which are similar execution in the preferred embodiment 1, are executed, and thereafter, the optimum recording power in the intermediate part is calculated for correction in a step S13a. The correction calculation of the optimum recording power is carried out by using the correction coefficient determined in the step S11c. Then, steps S14-S18, which are the same processing in the preferred embodiment 1, are executed.

In the present preferred embodiment, it is desirable that the OPC learning in the intermediate part be basically implemented more often as the property of the used optical disc is more inferior. Then, the optimum recording power in the current recording part can be accurately obtained in compliance with the variations of the sensitivity and film thickness in the surface. When the OPC learning is repeated in the intermediate part many times, it takes much time before the recording starts. In order to deal with the problem, it is desirable to set how many times the OPC learning should be performed in accordance with the property of the optical disc. The number of the OPC learning operations in accordance with the property of the optical disc can be experimentally calculated.

According to the present preferred embodiment, the optimum recording power in the intermediate part (land part 12) is corrected based on the OPC learning results in the groove part 11 and the land part 12 of the innermost peripheral part (may be the outermost peripheral part) before the data is recorded. Thereby, the CAV recording can be realized at a high quality.

Preferred Embodiment 4

In the OPC learning in the land part 12 of the intermediate part (data region), the level of the RF signal of the reflected light is attenuated if any surface defect, such as fingerprint or scratch, is present in the land part 12, and it gives the incorrect optimum recording power based on the OPC learning. A preferred embodiment 4 of the present invention solves the problem.

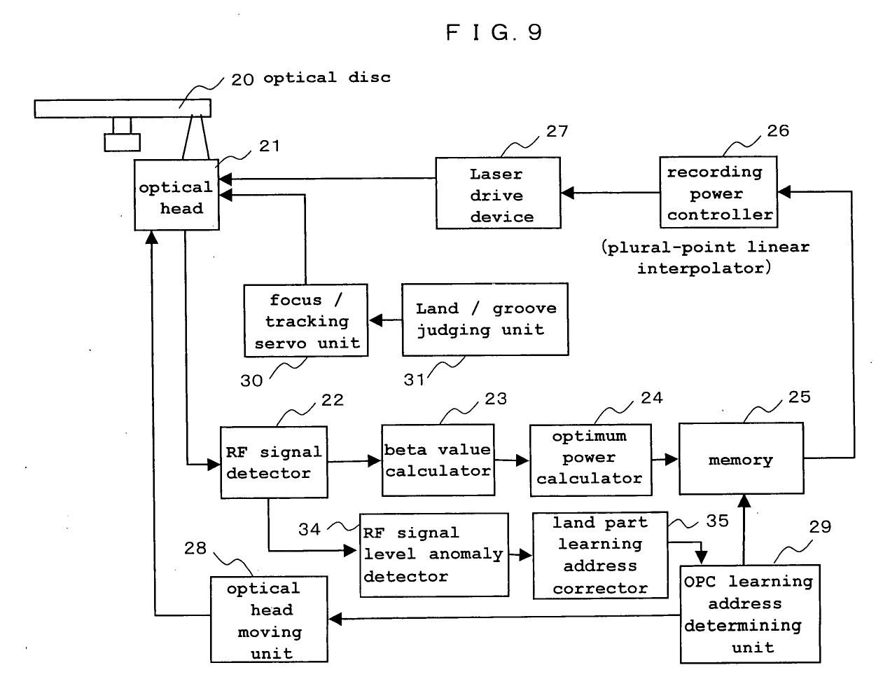

FIG. 9 is a block diagram illustrating a constitution of an optical disc recording control apparatus according to the preferred embodiment 4. In FIG. 9, a reference numeral 34 denotes an RF signal level anomaly detector. The RF signal level anomaly detector 34 detects if the level of the RF signal detected by the RF signal detector 22 shows any anomaly. A reference numeral 35 denotes a land part learning address corrector. The land part learning address corrector 35 determines the address of the OPC learning in the land part in order to execute the OPC learning again when the anomaly of the RF signal level is detected. The rest of the components are the same as those described in the preferred embodiment 1 (FIG. 2). The same components are simply provided with the same reference numerals and not described in detail again.

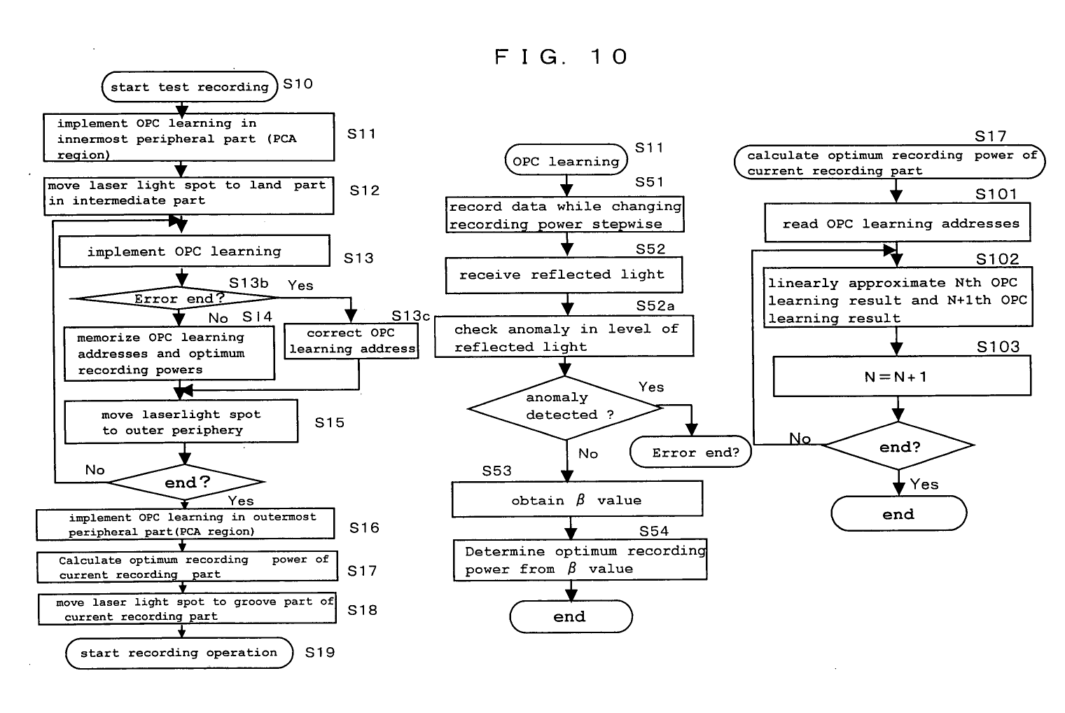

Below is specifically described an operation of the optical disc recording control apparatus according to the present preferred embodiment referring to a flow chart shown in FIG. 10. In the description below, a method for detecting the anomaly of the RF signal level in the OPC learning and a method for correcting the address at which the OPC learning is implemented again when the anomaly is detected are mainly described. The rest of the operations are similar to those of the preferred embodiment 1.

In a subroutine S11 of the OPC learning, the RF component is extracted in a step S52. In a next step S52a, it is judged by the RF signal level anomaly detector 34 whether or not the level of the extracted RF component is within a predetermined range. When it is judged that the level is not within the predetermined range, the RF component level is judged to show an anomalous value (error), and the relevant OPC learning is terminated. In the case that the recording operation for the OPC learning is executed in any part where the surface defect of the optical disc 20, such as fingerprint or scratch on the optical disc 20, is present, for example, the level of the RF signal as the reflected light is smaller than the RF signal level in the case that the recording operation is normally executed. The range of the RF signal level for judging the anomalous value can be experimentally calculated. When the extracted RF component level is within the predetermined range, a step 53 and steps thereafter are executed.

When the OPC learning is terminated due to the error, the disc radial position (address), where the OPC learning is currently performed, is corrected, and the OPC learning is performed again at the corrected radial position (S13b and S13c) When the OPC learning is normally terminated, the position shift amount of the OPC learning part in the radial direction of the disc and the optimum recording power calculated in the relevant OPC learning part are memorized in the memory 25 in a state that they correspond to each other (S14). Subsequent steps S15-S18 are similar to those in the preferred embodiment 1.

The surface defect, such as fingerprint or scratch on the optical disc, is inclined to be more present along the radial direction of the optical disc 20 than in a circumferential direction thereof. Therefore, when the OPC learning part is corrected according to the present method, the address of the OPC learning part is preferably set to any of the addresses continuous in the circumferential direction based on the part (address) as starting point where the OPC learning is terminated due to the error.

According to the present preferred embodiment, in the OPC learning in the intermediate part (data region) implemented before the data is recorded, the OPC learning part is switched to another part, where the OPC learning is implemented again, when the RF signal level is anomalous due to the surface defect such as fingerprint or scratch. As a result, the optimum recording power can be more accurately determined so that the recording can be realized at a high quality.

Preferred Embodiment 5

In the case where the surface defect, such as finger print or scratch, is present in the land part 12 of the optical disc 20 in the OPC learning in the land part 12 of the intermediate part, the beta value shows an anomalous value, and the optimum recording power set based on the OPC learning thereby becomes unfavorably inaccurate. A preferred embodiment 5 of the present invention solves the problem.

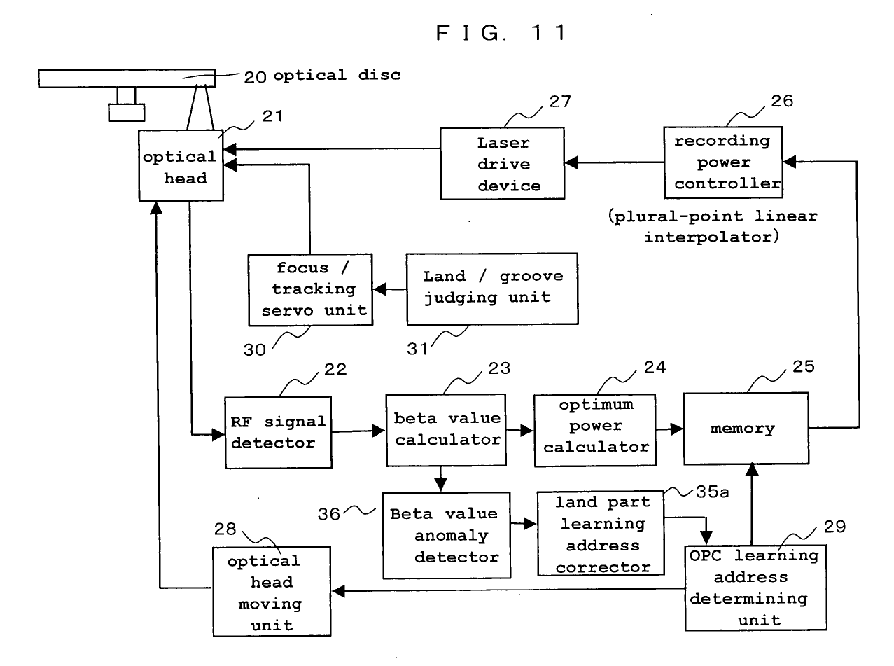

FIG. 11 is a block diagram illustrating a constitution of an optical disc recording control apparatus according to the preferred embodiment 5. In FIG. 11, a reference numeral 36 denotes a beta value anomaly detector for detecting the anomaly of the beta value calculated by the beta value calculator 23. A reference numeral 35a denotes a land part learning address corrector. The land part learning address corrector 35a determines the address in the intermediate part (radial position) where the OPC learning is implemented again when the anomaly of the beta value is detected. The rest of the constitution is similar to that of the preferred embodiment 1 shown in FIG. 2.

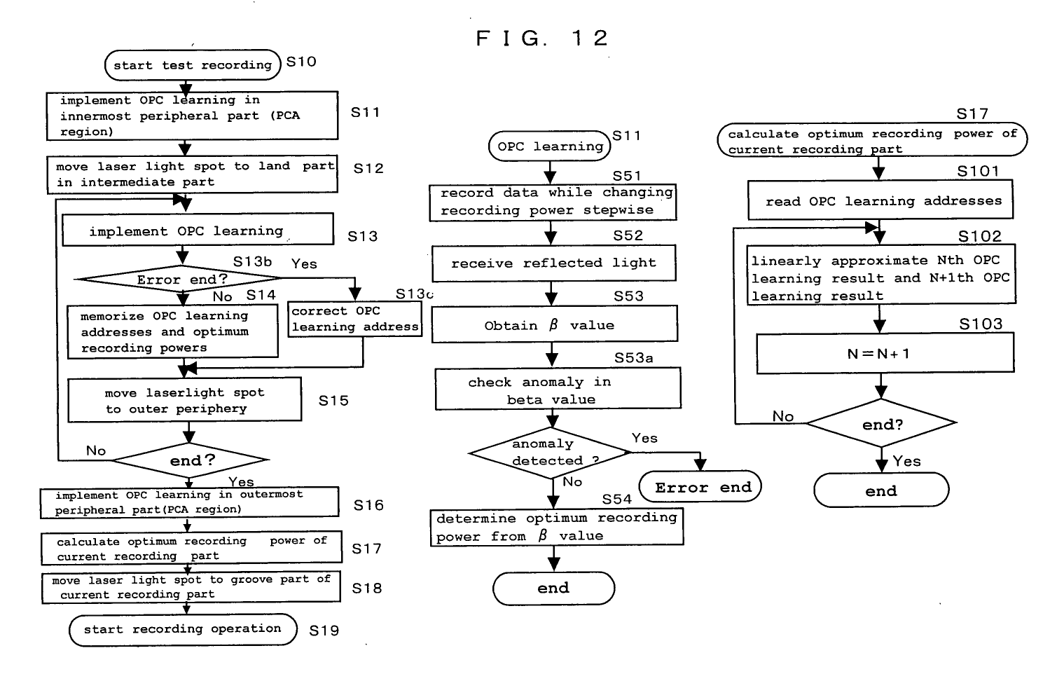

Below is specifically described an operation of the optical disc recording control apparatus according to the present preferred embodiment referring to a flow chart shown in FIG. 12. In the description below, a method for detecting the anomaly of the beta value in the OPC learning and a method for correcting the address where the OPC learning is implemented again when the anomaly is detected are mainly described. The rest of the components are similar to those described in the preferred embodiment 1 (FIG. 2). The similar components are simply provided with the same reference numerals and not described in detail again.

In the subroutine S11 of the OPC learning, the beta value is calculated in a step S53, and the beta value anomaly detector 36 judges whether or not the calculated beta value is within a predetermined range in a subsequent step S53a. When it is judged that the beta value is not within the predetermined range, the beta value is judged to show an anomalous value (error) and the OPC learning is terminated. In the case that the part on the optical disc having the surface defect, such as fingerprint or scratch thereon, is set as the OPC learning part, the level of the RF signal as the reflected light is smaller than the RF signal level in the normal recording operation. Therefore, the beta value calculated from the RF signal shows a value different to that of the normal recording operation. The range of the beta value for judging the anomalous value can be experimentally calculated. When the calculated beta value is within the predetermined range, a step S54 is implemented next.

When the OPC learning is terminated due to the error, the disc radial position (address), where the OPC learning is currently performed, is changed, and the OPC learning is performed again in the part to be changed (S13c). When the OPC learning is normally terminated, the OPC learning part and the calculated optimum recording power are memorized in the memory 25 in a state that they correspond to each other (S14). Subsequent steps S15-S18 are similar to those in the preferred embodiment 1.

In the method to change a part of the OPC learning part, it is preferable to correct the address of the OPC learning part is preferably set to any of the addresses continuous in the circumferential direction based on the part (address) as starting point where the OPC learning is terminated due to the error in a manner similar to the preferred embodiment described earlier.

According to the present preferred embodiment, in the part where the OPC learning is implemented before the data is recorded, the OPC learning part is changed so that the OPC learning is implemented there again when the anomaly of the beta value is detected due to the surface defect such as fingerprint or scratch. As a result, the optimum recording power can be more accurately determined, and the recording operation is thereby achieved at a high quality.

Preferred Embodiment 6

In a preferred embodiment 6 of the present invention, the recording power controller consists of the structure to execute a linear interpolation by means of the least squares method in place of the plural-point linear interpolation. In the preferred embodiments 1-5, the optimum recording powers are prepared in the table and registered in the memory. In the case of using the optimum recording power table, the processing load in the firmware which generates the table is large. The present preferred embodiment deals with the inconvenience.

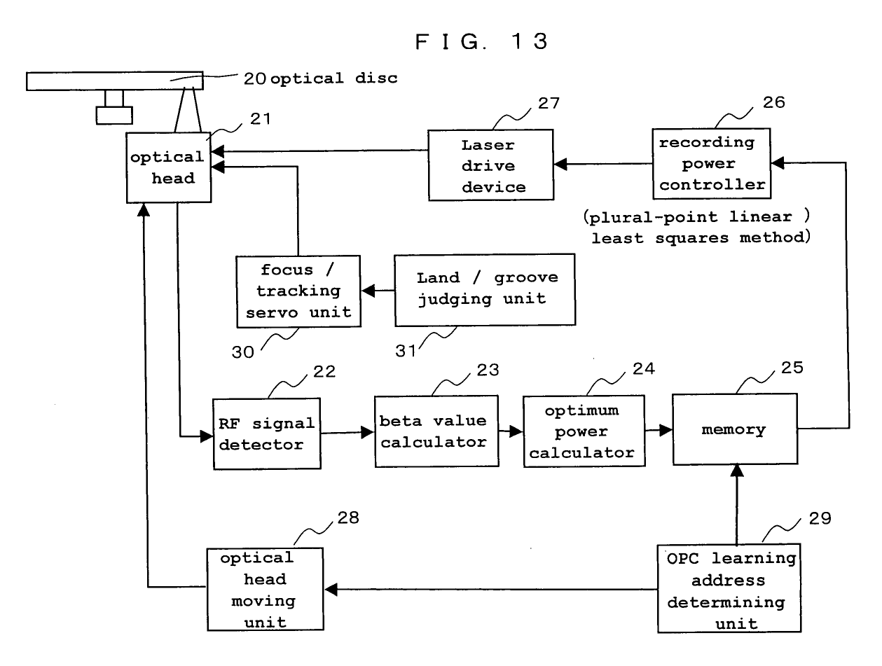

FIG. 13 is a block diagram illustrating a constitution of an optical disc recording control apparatus according to the preferred embodiment 6. In the present preferred embodiment, a least squares method linear interpolator is provided in the constitution according to the preferred embodiment 1 (FIG. 2) as the recording power controller in place of the plural-point linear interpolator in the preferred embodiments 1-5. The rest of the components are the same as those described in the preferred embodiment 1 (FIG. 2). The same components are simply provided with the same reference numerals and not described in detail again.

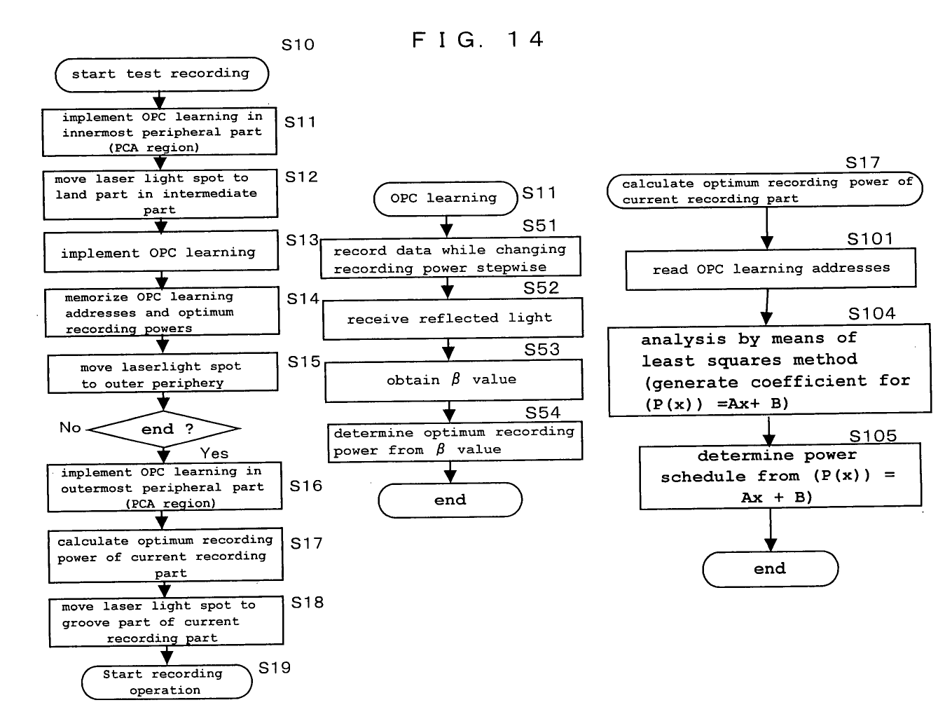

Below is described an operation of the optical disc recording control apparatus according to the present preferred embodiment referring to a flow chart shown in FIG. 14. In the present preferred embodiment based on the preferred embodiment 1, a method for determining the optimum recording power of the current recording part using the approximation by means of the least squares method is mainly described. The other operations, which are the OPC operation and the operations after the optimum recording power is determined, are similar to those in the preferred embodiment 1.

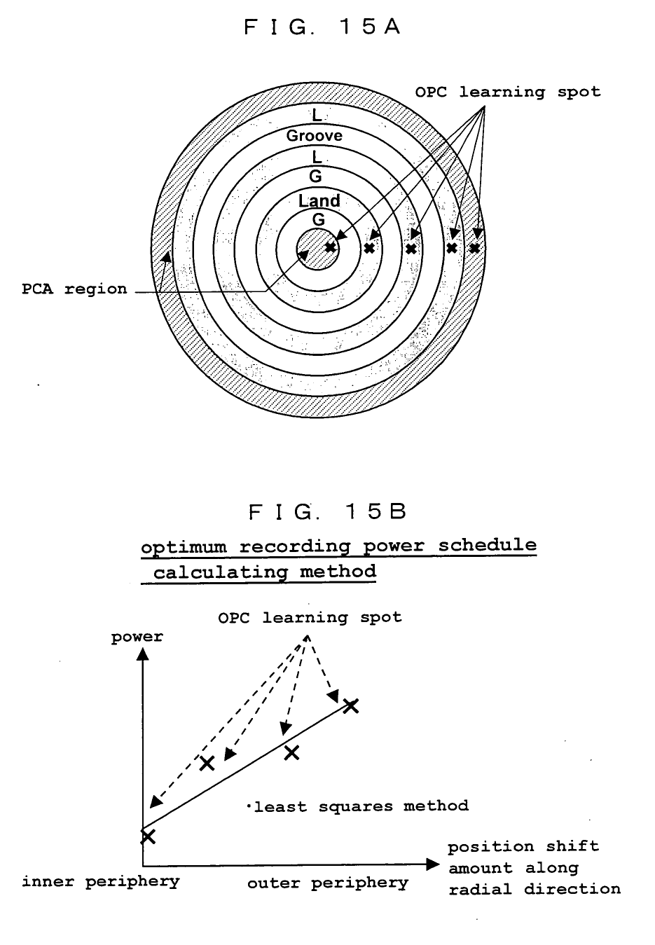

In a manner similar to the preferred embodiment 1, the OPC learning is implemented in the innermost peripheral, outermost peripheral and intermediate parts, and the OPC learning results obtained are memorized in the memory 25 in a state where they correspond to the position shift amounts of the respective parts in the radial direction of the disc. Next, the optimum recording power in the current recording part is determined when the data is recorded (S17). When the optimum recording power in the current recording part is determined, the OPC learning results calculated in the previous step and the position shift amounts of the OPC learning parts in the radial direction are read from the memory 25 (S10). Then, a linear approximate expression by means of the least squares method, [P(x)=Ax+B], is generated from all of the OPC learning results as shown in FIG. 15B (S104). The optimum recording power in the current recording part is calculated by means of the approximate expression (S105). Then, the optical head 21 is moved to the groove part 11 (S18), and the CAV recording is started based on the calculated optimum recording power in the current recording part (S19).

According to the present preferred embodiment, without using the optimum recording power table, the data is recorded after the optimum recording power corresponding to the current address is calculated according to such a simple linear approximate expression by means of the least squares method, [P(x)=Ax+B], in the middle of the data recording operation. Thereby, the recording operation can be achieved at a higher speed in the circumstances of the reduced processing load in the firmware. Further, the ultimate optimum recording power is determined in such a manner that any influence from the surface defect locally generated (scratch or black dot) is eliminated. As a result, the CAV recording can be achieved at a higher quality.

The technology described in the present preferred embodiment can be applied to the preferred embodiments 2-5.

Preferred Embodiment 7

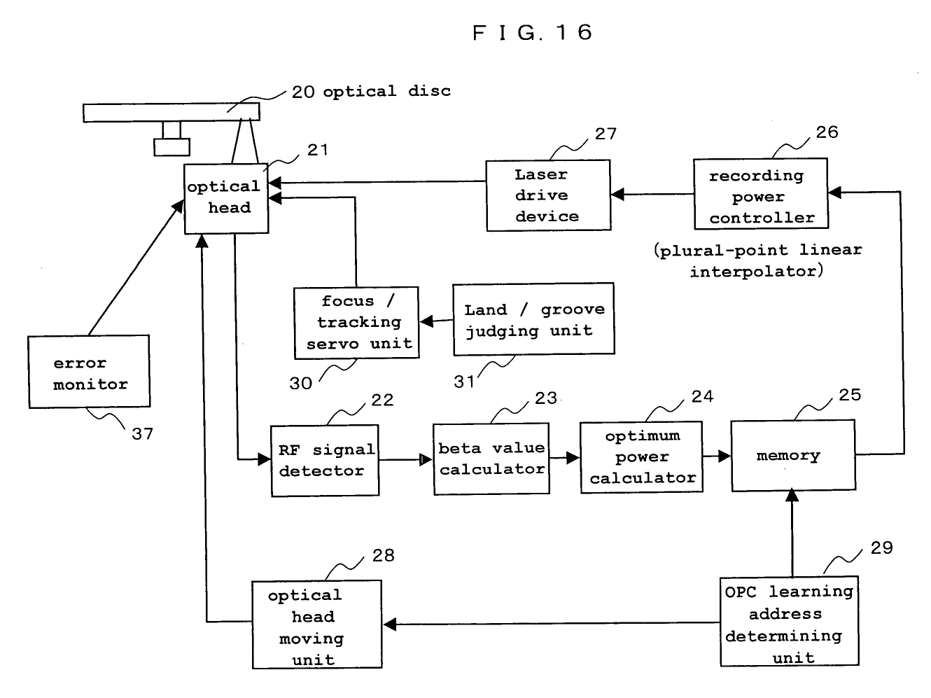

FIG. 16 is a block diagram illustrating a constitution of an optical disc recording control apparatus according to a preferred embodiment 7 of the present invention. In FIG. 16, any component, which is the same as that of the preferred embodiment 1 (FIG. 2), is simply provided with the same reference numeral and not described in detail again. An error monitor 37 is provided in the present preferred embodiment. The error monitor 37 monitors an error such as a buffer under-run, temporarily terminates the data recording operation when the error is generated, and then, performs the OPC learning again The rest of the constitution is similar to that of the preferred embodiment 1.

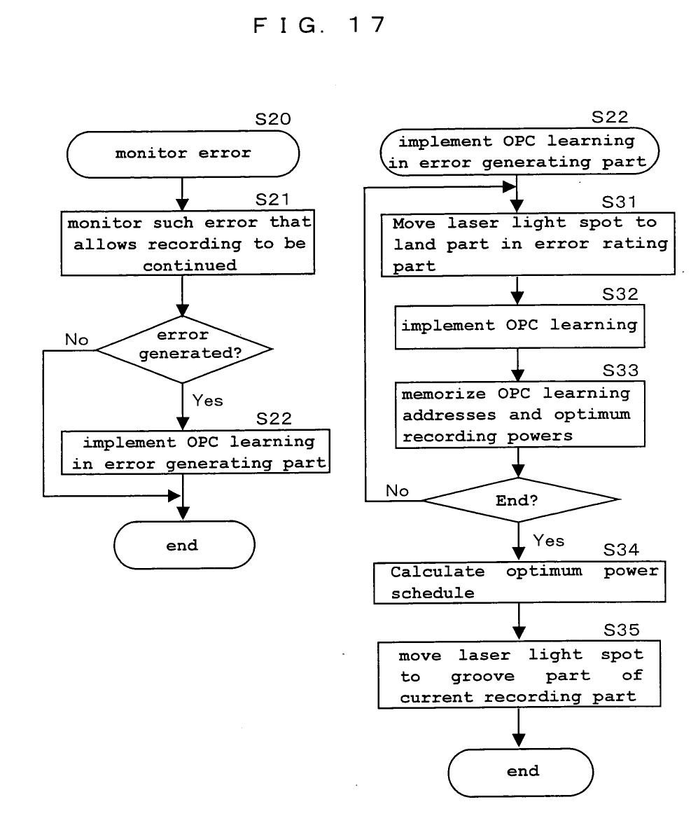

Below is specifically described an operation of the optical disc recording control apparatus according to the present preferred embodiment referring to a flow chart shown in FIG. 17. A recording method according to the present preferred embodiment is similar to that of the preferred embodiment 1. In the preferred embodiment 7, the recording method described below is repeated when the recording operation is temporarily halted.

When the recording operation is temporarily halted due to the generation of the error during the operation similar to that of the preferred embodiment 1, the error monitor 37 recalculates the optimum recording power at a position where the error is generated (recording part) (S20). More specifically, the error monitor 37 continuously monitors the error (S21), and performs the OPC learning at a position when the error is generated (S22) in case of the error generation. The OPC learning at position of the error generation follows steps S31-35. More specifically, the optical head 21 is moved so that the laser light spot reaches the land part 12 in closest vicinity of the error generating position (S31) and the OPC learning is performed there (S32). The thus calculated disc radial position (address) of the OPC learning part and optimum recording power are additionally memorized in the memory 25 as a correlation (S33). When the data is recorded, the optimum recording power in the current recording part is determined based on the correlation in which the optimum recording power at the error generating position is additionally recorded (S34). In the optimum recording power in the current recording part, the OPC learning result calculated in the previous step and each of the positions in a radial direction of the disc (addresses) is read from the memory 25,and then, the optimum recording power is calculated in the current recording part by treatment of the two-point linear approximation (see FIG. 4) based on the OPC learning result in the error generating position (recording part immediately before the current recording part) and the OPC learning result in the OPC learning part adjacent to each other in the forward side of the current recording part. After the foregoing processing, the optical head 21 is moved to the radial position (error generating point) where the data recording is temporarily halted (S35) so as to restart the data recording.

In the present preferred embodiment, it is desirable that the OPC learning in the intermediate part be basically implemented more often as the property of the used optical disc is more inferior. Then, the optimum recording power in the current recording part can be accurately obtained in compliance with the variations of the sensitivity and film thickness in the surface. When the OPC learning is repeatedly performed in the land part many times, it takes much time before the recording starts. The number of the OPC learning operations is desirably set in accordance with the property of the optical disc. The number of the OPC learning operations in accordance with the property of the optical disc can be experimentally calculated.

According to the present preferred embodiment, in the case where the error is still generated in the data recording after the OPC learning is repeated in the intermediate part prior to the data recording, the error generation part can be utilized as the OPC learning part so that the optimum recording power can be more accurately determined. Thereby, the CAV recording can be realized at a high quality, and the recorded data can be reproduced in an optical disc reproducing apparatus supplied by other companies.

Preferred Embodiment 8

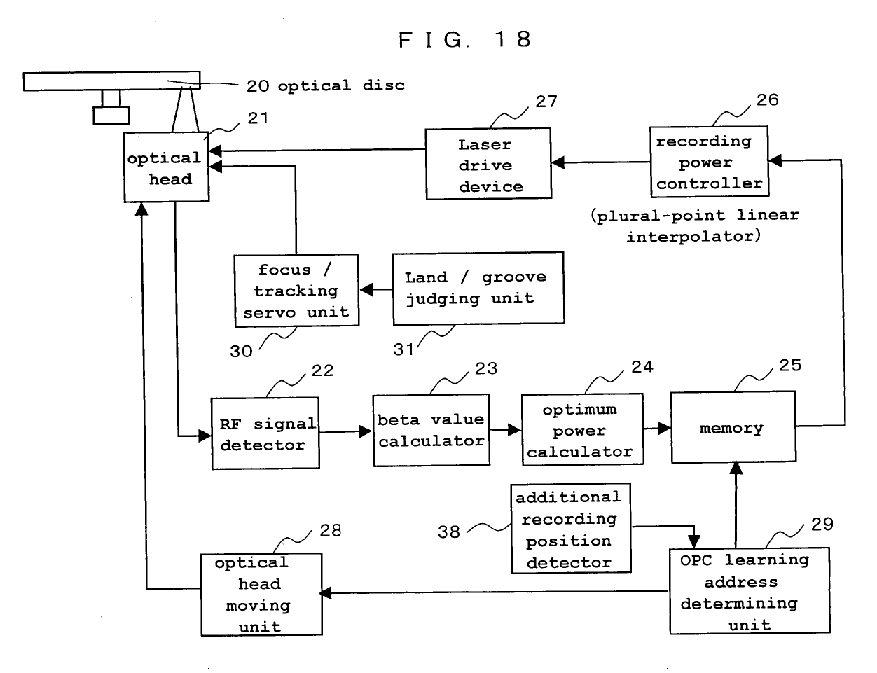

FIG. 18 is a block diagram illustrating a constitution of an optical disc recording control apparatus according to a preferred embodiment 8 of the present invention. In FIG. 18, any component, which is the same as that of the preferred embodiment 1 (FIG. 2), is simply provided with the same reference numeral and not described in detail again. In the present preferred embodiment, an additional recording position detector 38 for detecting an additional recording position when the data is additionally recorded in the optical disc is further provided.

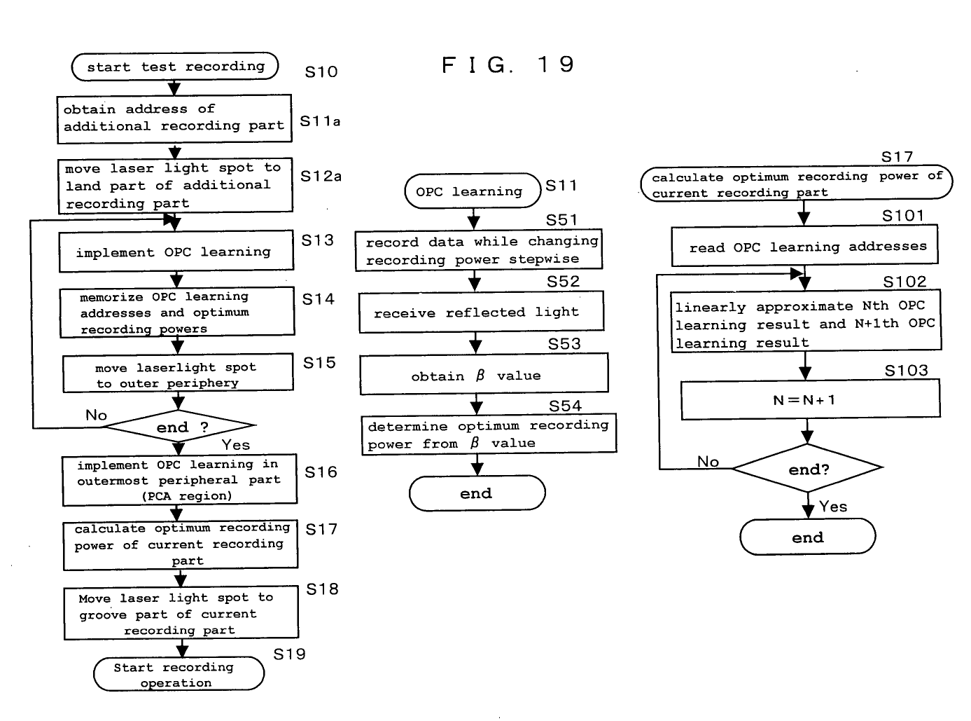

Below is specifically described an operation of the optical disc recording control apparatus according to the present preferred embodiment referring to a flow chart shown in FIG. 19.

When the data is additionally recorded in the optical disc, the test recording is implemented in order to calculate the optimum recording power used for the data recording before the data is recorded (S10). In the test recording, first, the additional recording position recorder 38 obtains the position in a radial direction of the disc (address) in the additional recording position where the additional recording operation starts (S11a). Next, the optical signal processing circuit in the optical head 21 is controlled so that the laser light spot is moved to the land part of the additional recording part (S12a), and the OPC learning is performed in the relevant part (S13). On and after the OPC learning (S13), processing similar to those in the preferred embodiment 1 are executed.

In the present preferred embodiment, the additional recording part is reduced in the case where the optimum recording power in the central part equal to that of the preferred embodiment 1 is obtained. Therefore, the number the OPC learning operations can be reduced, that is, a time length for performing the OPC learning can be cut down. In the case of performing the OPC learning as often as described in the preferred embodiment 1, the more accurate optimum recording power can be obtained in the same amount of time for the OPC learning. The number of the OPC learning operations in accordance with the property of the optical disc can be experimentally calculated.

According to the present preferred embodiment, the OPC learning is performed in the additional recording part prior to the additional recording with respect to the optical disc. As a result, the OPC learning time can be reduced, the optimum recording power can be more accurately determined, and the additional recording operation can be achieved at a high quality.

Preferred Embodiment 9

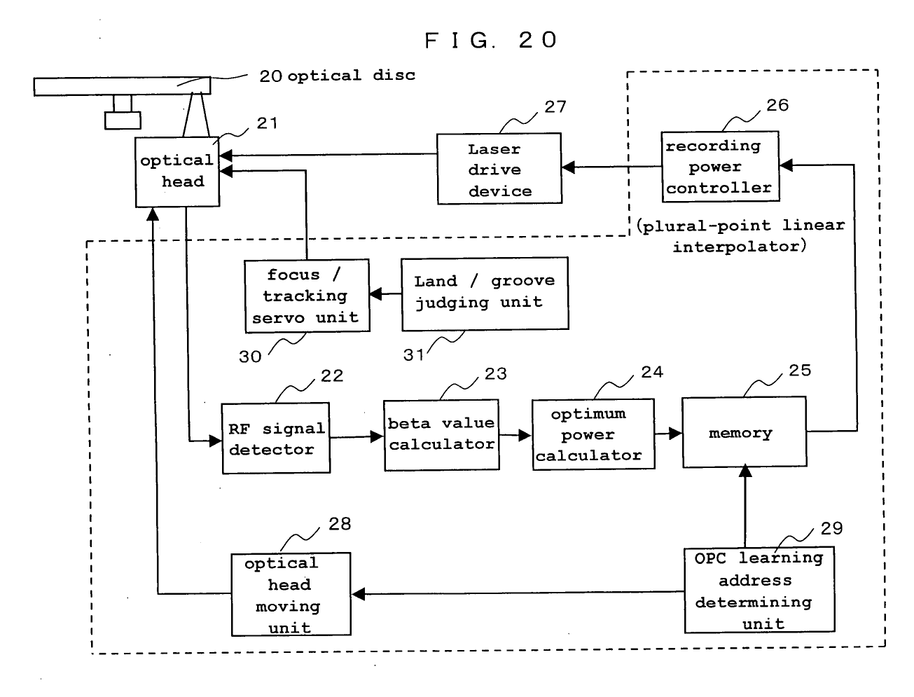

FIG. 20 is a block diagram illustrating a constitution of an optical disc recording control apparatus according to a preferred embodiment 9 of the present invention. In FIG. 20, any component, which is the same as that of the preferred embodiment 1 (FIG. 2), is simply provided with the same reference numeral and not described in detail again. In the present preferred embodiment, a square part surrounded by a dotted line denotes a configuration of a signal circuit for performing the recording control according to the present preferred embodiment.

The constitution according to the present preferred embodiment comprises a recording power controller 26. The recording power controller 26 generates a drive current control signal approximate to the plurality of OPC learning results based on the calculation result of the optimum power calculator 24, and outputs the generated drive current control signal to the laser drive device 27.

An operation of the optical disc apparatus according to the present preferred embodiment is similar to that of the preferred embodiment 1.

Embodiment 10

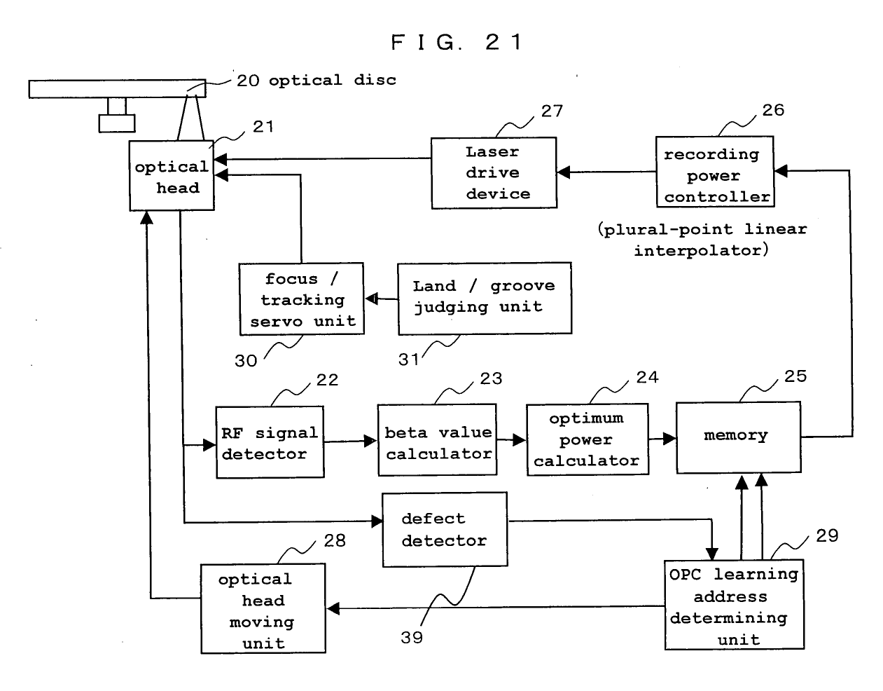

FIG. 21 is a block diagram illustrating a constitution of an optical disc recording control apparatus according to a preferred embodiment 10 of the present invention. In FIG. 21, any component, which is the same as that of the preferred embodiment 1 (FIG. 2), is simply provided with the same reference numeral and not described in detail again. In the present preferred embodiment, a defect detector 39 for detecting whether or not the surface defect, such as fingerprint or scratch, is present in the part of the disc where the OPC learning is implemented in the OPC learning for the optical disc is further provided.

To the defect detector 39 is inputted the output of the photo detector (not shown) to detect the laser light reflected from the optical disc 20 included in the optical head 21. The defect detector 39 judges the presence of the surface defect, such as fingerprint or scratch, in the part of the optical disc 20 where the laser light is irradiated when detecting that the output level of the photo detector is attenuated in comparison to a predetermined value. The defect detector 39 supplies the judgment result to the OPC learning address determining unit 29. The OPC learning address determining unit 29 informed of the presence of the surface defect on the laser light irradiation part in the optical disc 20 by the defect detector 39 outputs an OPC learning position change instruction to the optical head moving unit 28. The OPC learning position change instruction indicates the movement of the optical head 21 to any part in the optical disc where the surface defect is not present.

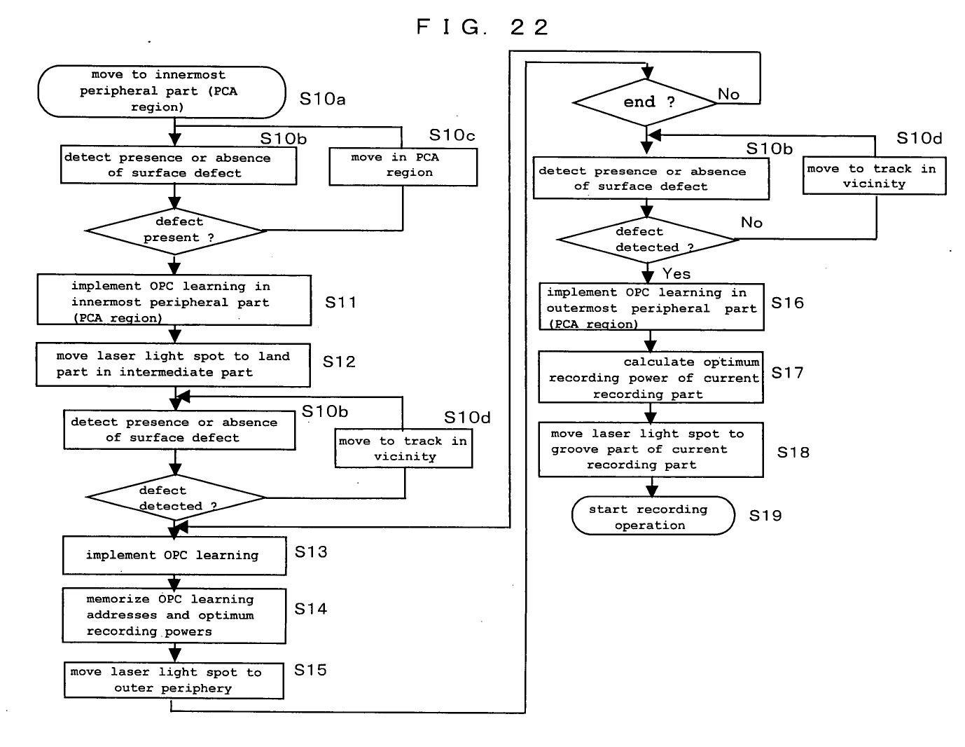

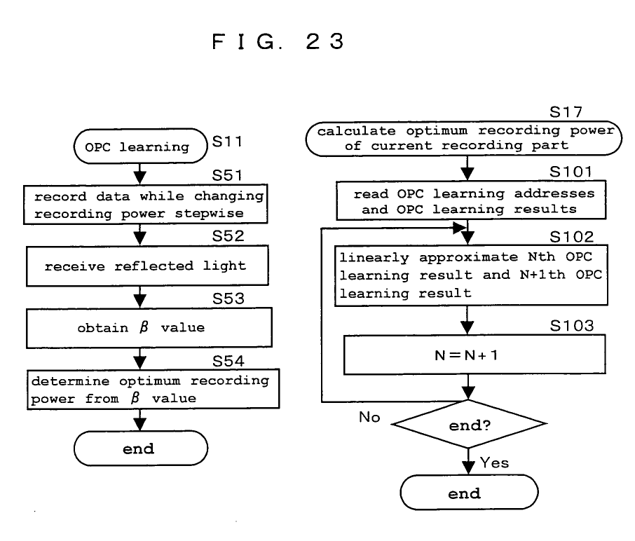

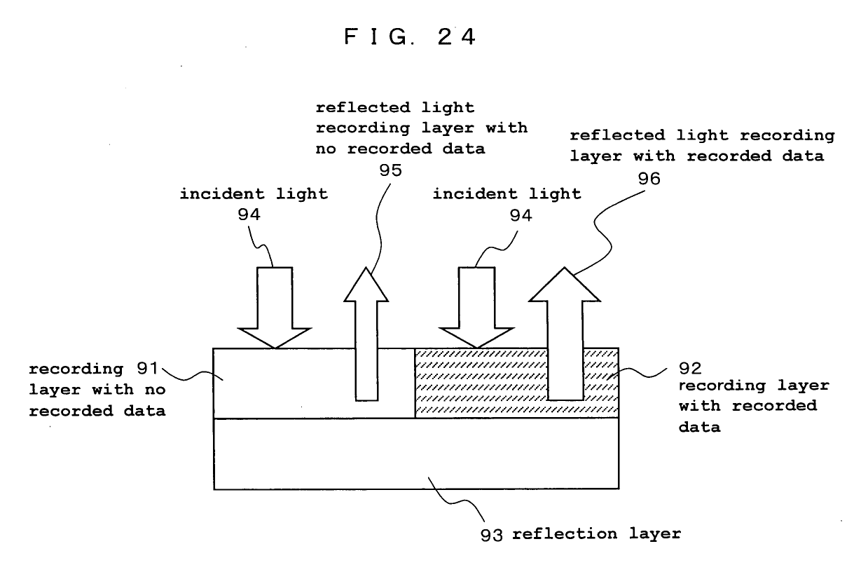

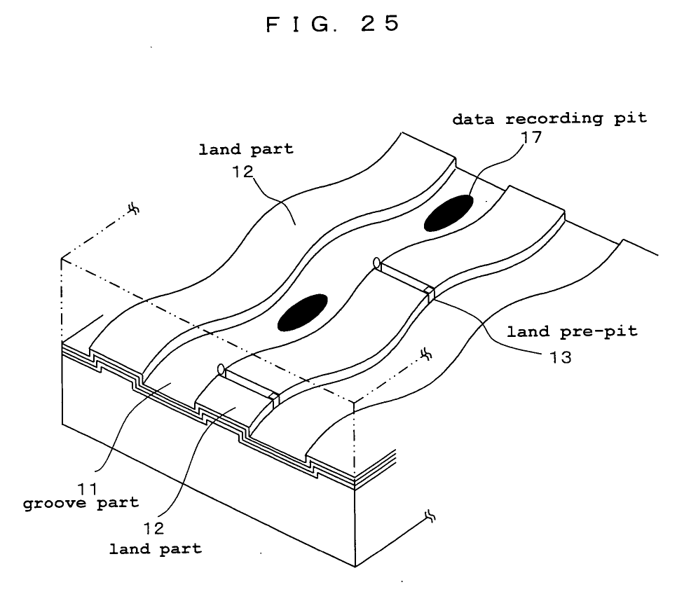

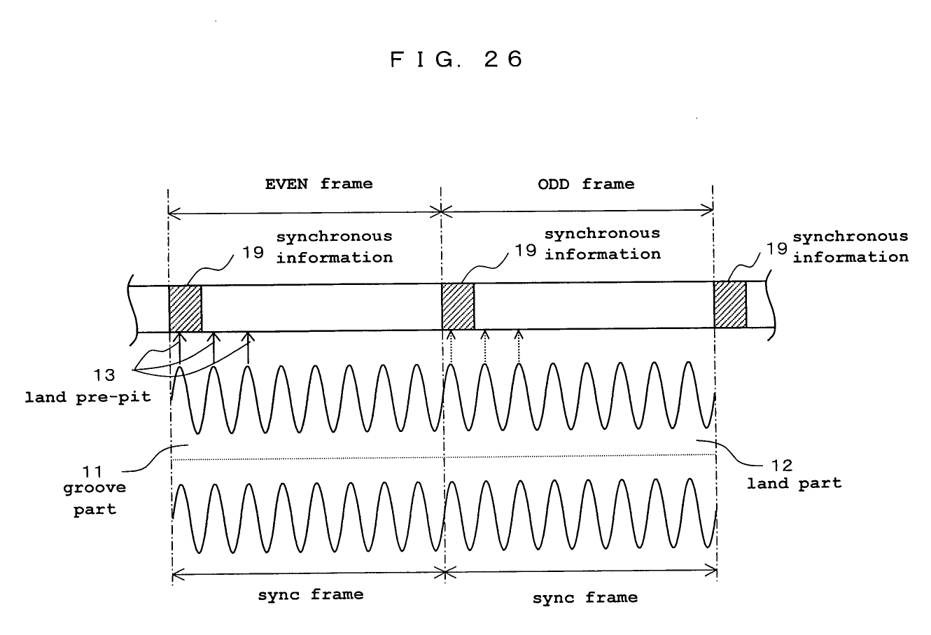

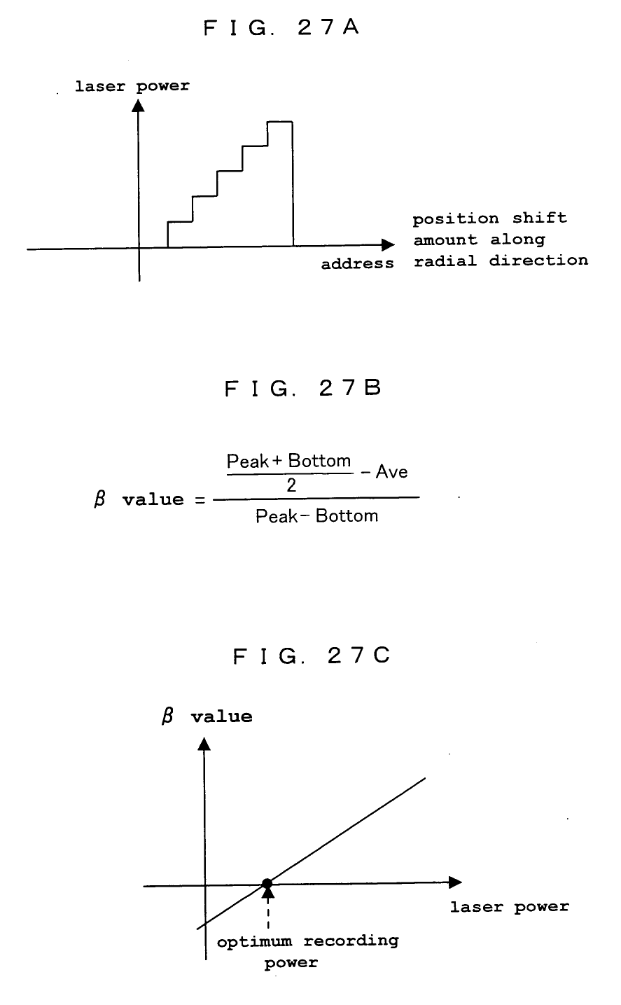

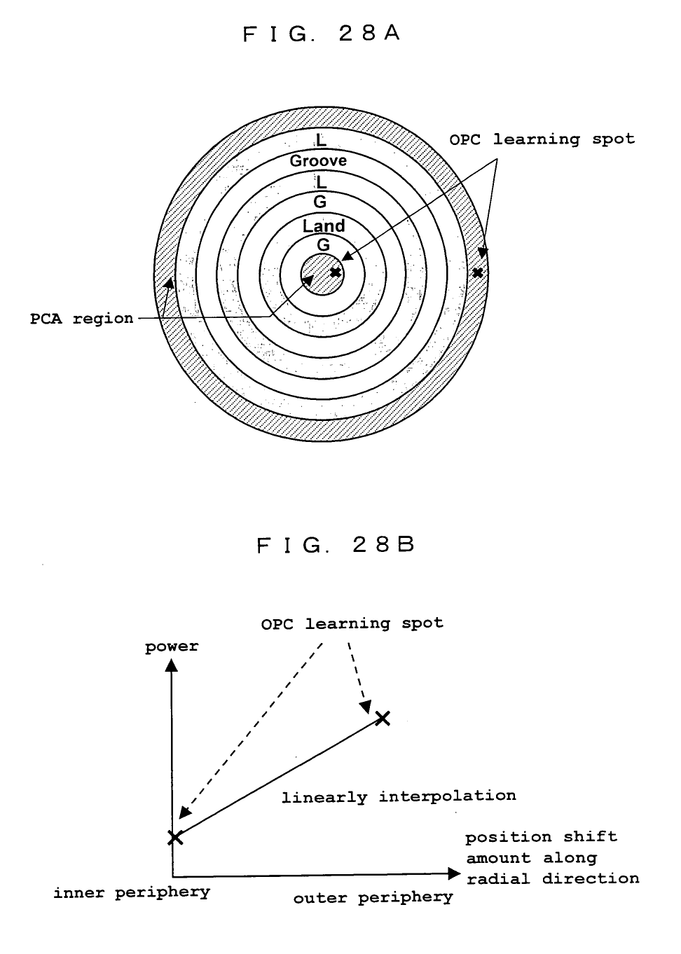

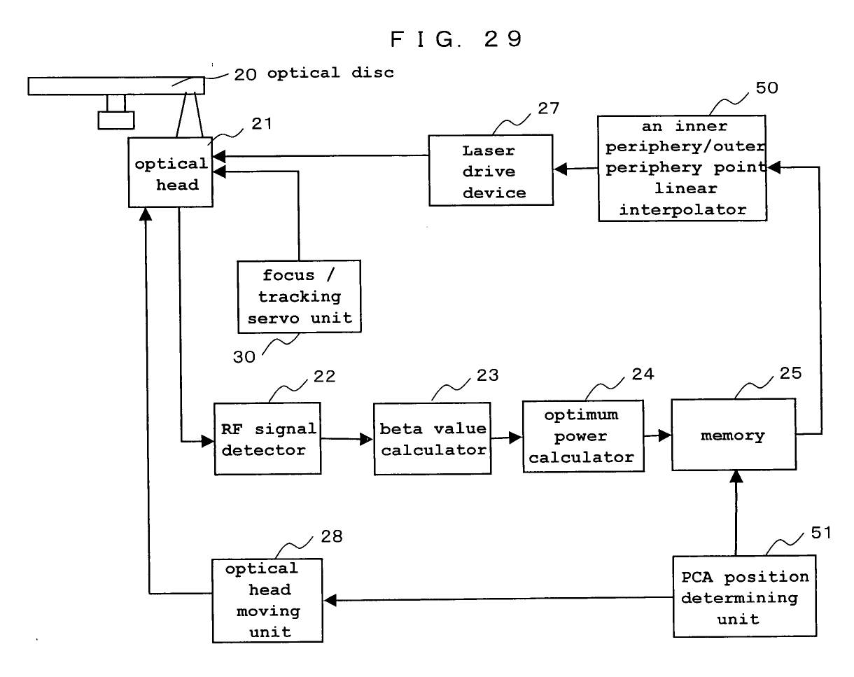

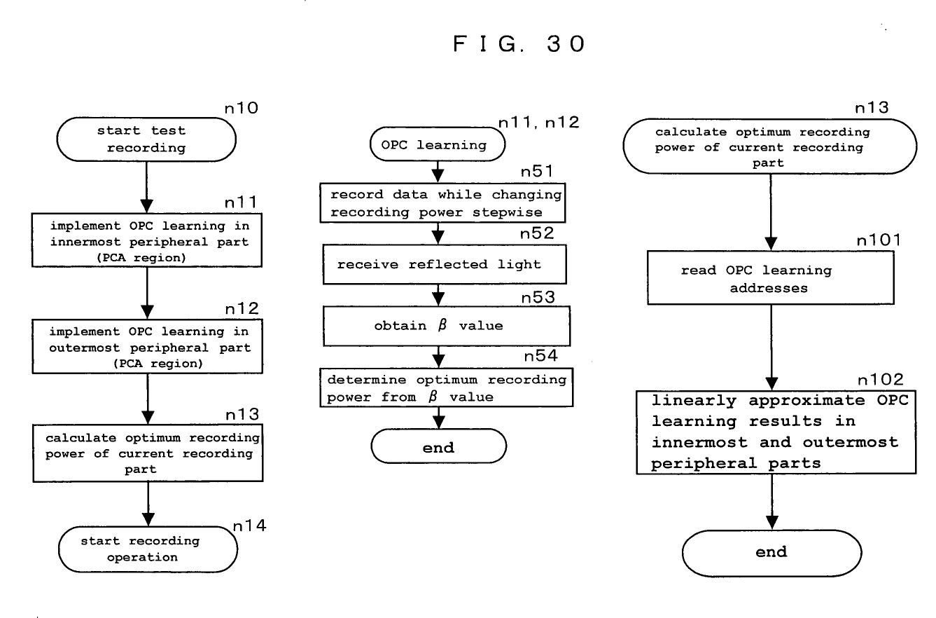

Below is specifically described an operation of the optical disc recording control apparatus according to the present preferred embodiment referring to flow charts shown in FIGS. 22 and 23. Before the data is recorded in the optical disc, the recording position of the optical head 21 is moved in order to calculate the optimum recording power used in the data recording (S10a). The destination of the movement is set in the track (preferably, groove part 11) of the PCA region in the innermost periphery where the OPC learning is implemented. Next, the presence or absence of the surface defect in the region where the test recording is implemented is confirmed in a state where the power of the laser light emitted onto the optical disc 20 is set to a constant level (S10b). When the surface defect is detected in the region for the test recording in the step S10b, the defect detector 39 issues an instruction for moving the recording position of the optical head 20 to a different position in the relevant PCA region to the OPC learning address determining unit 29 and the optical head moving unit 28. The optical head moving unit 28, which received the instruction, moves the recording position of the optical head 21 to the different position in the PCA region designated by the OPC learning address determining unit 29 (part assumed not to include any surface defect) (S10c). Then, the step S10b is implemented again. When the surface defect is not detected in the region where the test recording is implemented in the step S10, the step S10c is omitted, and the OPC learning is implemented (S11). On and after the OPC learning (S13), the processing similar to those in the preferred embodiment 1 are executed.

The steps S10a-10c may be implemented prior to the steps (S13 and S16) in which the OPC learning is implemented in the intermediate part (data recording region) and in the outermost peripheral part. In that case, the optical head 21 is set to move, not in the PCA region, but in vicinity of the track where the OPC learning is implemented in the step S10c (S10d in FIG. 22).

According to the present preferred embodiment, in the OPC learning implemented prior to the data recording, the significant deterioration of the OPC learning accuracy due to the anomaly of the RF signal level resulting from the surface defect such as fingerprint or scratch, or the generation of the error such as the failure of the OPC learning can be prevented before the implementation of the OPC learning. As a result, the high-quality recording operation in which the optimum recording power is more accurately determined can be realized.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. An optical disc recording control method comprising:
a step for calculating an optimum recording power based on OPC (Optimum Power Control) learning in an inner peripheral part and an outer peripheral part of an optical disc, and at least one of the intermediate parts between the inner and outer peripheral parts respectively before data is recorded in the optical disc; and
a step for setting the optimum recording power in a current recording part based on a correlation between position shift amounts in a radial direction of the optical disc in the inner peripheral part the outer peripheral part and the intermediate part, and the optimum recording powers calculated in the respective parts so as to record the data to the optical disc by executing laser drive control using the set optimum recording power.

2. The optical disc recording control method of claim 1, wherein
the optical disc has a track which comprises a groove part in which the data is recorded and a land part in which an auxiliary information is recorded, wherein
the optimum recording power in the land part is calculated based on the OPC learning in the intermediate part.

3. The optical disc recording control method of claim 2, wherein
the optimum recording power in the groove part is calculated in the inner peripheral part and in the outer peripheral part.

4. The optical disc recording control method of claim 1, wherein
the optimum recording power in PCA (Power Calibration Area) is calculated in the inner peripheral part and in the outer peripheral part.

5. The optical disc recording control method of claim 1, further including,
a step for detecting whether or not any surface defect is present in the inner peripheral part, the outer peripheral part or the intermediate part prior to the step for calculating the optimum recording power based on the OPC learning in the inner peripheral part, the outer peripheral part or the intermediate part, wherein
a position in a radial direction of a disc in the inner peripheral part, the outer peripheral part or the intermediate part where the surface defect is detected, is changed to a position where the surface defect is not present, and the optimum recording power is then calculated based on the OPC learning in the step for calculating the optimum recording power based on the OPC learning.

6. An optical disc recording control apparatus comprising:
an optical head for recording data to an optical disc;
an OPC learning address determining unit for determining a position in a radial direction of the disc in an inner peripheral part of the optical disc, a position in a radial direction of the disc in an outer peripheral part of the optical disc, and a position in a radial direction of the disc in at least one of the intermediate parts between the inner and outer peripheral parts which become an object of the OPC (Optimum Power Control) learning before data is recorded in the optical disc;
an optical head moving unit for moving the optical head respectively to the inner peripheral part, the outer peripheral part and the intermediate part, where the positions in a radial direction of disc are determined by the OPC learning address determining unit;
an optimum power calculator for calculating an optimum recording power in the inner peripheral part, the outer peripheral part and the intermediate part from an information representing an irregularity of a property of the optical disc included in a laser light emitted from the optical head moved respectively to the inner peripheral part, the outer peripheral part and the intermediate part and thereafter reflected from the optical disc;
a memory for memorizing a correlation between position shift amounts along a radial direction of the optical disc in the inner peripheral part, the outer peripheral part and the intermediate part determined by the OPC learning address determining unit, and the optimum recording powers in the respective parts calculated by the optimum power calculator;
a recording power controller for setting the optimum recording power in a current recording part of the optical disc based on the correlation read from the memory when the data is recorded; and
a laser drive device for recording the data to the optical disc via the optical head while controlling the optimum recording power in the current recording part of the optical disc by the set value of the recording power controller when the data is recorded.

7. The optical disc recording control apparatus of claim 6, wherein
the optical disc has a track which comprises a groove part in which the data is recorded and a land part in which an auxiliary information is recorded, and
the OPC learning address determining unit determines the position in a radial direction of the disc in an arbitrary land part in the intermediate part as the position in a radial direction of the disc in the intermediate part.

8. The optical disc recording control apparatus of claim 7, wherein
the OPC learning address determining unit determines the position in a radial direction of the disc in an arbitrary groove part in the inner peripheral part or in the outer peripheral part as the position in a radial direction of the disc in the inner peripheral part and the position in a radial direction of the disc in the outer peripheral part.

9. The optical disc recording control apparatus of claim 6, wherein
the OPC learning address determining unit determines the position in a radial direction of the disc in PCA (Power Calibration Area) in the inner peripheral part or in the outer peripheral part as the position in a radial direction of the disc in the inner peripheral part and the position in a radial direction of the disc in the outer peripheral part.

10. The optical disc recording control apparatus of claim 6, further comprising:
an RF signal detector for detecting the RF signal included in a detected signal of the laser light; and
a beta value calculator for measuring a beta value representing the irregularity of the property of the optical disc from the RF signal detected by the RF signal detector, wherein
the optimum power calculator handles the beta value measured by the beta value calculator as the information representing the irregularity of the property of the optical disc.

11. The optical disc recording control apparatus of claim 7, further comprising a groove recording power corrector, wherein
the groove recording power corrector corrects the optimum recording power in the land part of the intermediate part calculated by the optimum power calculator into the optimum recording power in the groove part of the intermediate part.

12. The optical disc recording control apparatus of claim 7, further comprising a land/groove corrector, wherein
the land/groove corrector corrects the optimum recording power in the land part of the intermediate part calculated by the optimum power calculator so that any influence, which is given to the groove part adjacent to the relevant land part by the laser light irradiation to obtain the optimum recording power in the land part, is eliminated.

13. The optical disc recording control apparatus of claim 12, wherein
the land/groove corrector corrects the optimum recording power in the land part of the intermediate part based on a result of comparing each other the laser lights reflected from the groove part and the land part in the inner peripheral part or in the outer peripheral part so that any influence, which is given to the groove part adjacent to the relevant land part by the laser light irradiated in order to obtain the optimum recording power in the land part, is eliminated.

14. The optical disc recording control apparatus of claim 10, further comprising:
an RF signal level anomaly detector for detecting whether or not any anomaly is generated in a level of the RF signal detected by the RF signal detector when the optimum power calculator calculates the optimum power; and
a land part learning address corrector for correcting the position in a radial direction of the disc where the anomaly is detected when the RF signal level anomaly detector detects the anomaly, wherein
the optical head moving unit moves the optical head to the position in a radial direction of the disc corrected by the land part learning address corrector, and
the optimum power calculator recalculates the optimum recording power in each of the positions in a radial direction of the disc from the information representing the irregularity of the property of the optical disc included in the laser light emitted from the optical head moved to the corrected position in a radial direction of the disc and thereafter reflected from the optical disc.

15. The optical disc recording control apparatus of claim 10, further comprising:
a beta value anomaly detector for detecting whether or not the beta value calculated by the beta value calculator produces any anomaly when the optimum power calculator calculates the optimum power; and
a land part learning address corrector for correcting the position in a radial direction of the disc where the anomaly is detected when the beta value anomaly detector detects the anomaly, wherein
the optical head moving unit moves the optical head to the position in a radial direction of the disc corrected by the land part learning address corrector, and
the optimum power calculator recalculates the optimum recording power in each of the positions in a radial direction of the disc from the information representing the irregularity of the property of the optical disc included in the laser light emitted from the optical head moved to the corrected disc radial position and thereafter reflected from the optical disc.

16. The optical disc recording control apparatus of claim 6, wherein
the recording power controller performs a linear interpolation treatment of the correlation to thereby set the optimum recording power in the current recording part.

17. The optical disc recording control apparatus of claim 6, wherein
the recording power controller treats the correlation by means of least squares method to thereby set the optimum recording power in the current recording part.

18. The optical disc recording control apparatus of claim 6, further comprising an error monitor for interrupting the recording when any error raising the recording interruption is generated when the data is recorded, wherein
the optical head moving unit moves the optical head to the position in a radial direction of the disc in which the error is generated,
the optimum power calculator calculates the optimum recording power in the position in a radial direction of the disc where the error is generated from the information representing the irregularity of the property of the optical disc included in the laser light emitted from the optical head moved to the position in a radial direction of the disc where the error is generated and thereafter reflected from the optical disc, and
the memory memorizes the correlation to which the optimum recording power in the position in a radial direction of the disc where the error is generated, that is calculated by the optimum power calculator, is added.

19. The optical disc recording control apparatus of claim 6, further comprising an additional recording position detector for detecting the position in a radial direction of the disc of an additional recording position when the data is additionally recorded in the optical disc, wherein
the optical head moving unit moves the optical head to the additional recording position whose position in a radial direction of the disc is detected by the additional recording position detector,
the optimum power calculator calculates the optimum recording power at the additional recording position from the information representing the irregularity of the property of the optical disc included in the laser light emitted from the optical head moved to the additional recording position and thereafter reflected from the optical disc, and
the memory memorizes the correlation to which the optimum recording power in the additional recording position calculated by the optimum power calculator is added.

20. The optical disc recording control apparatus of claim 6, further comprising a defect detector for detecting whether or not any surface defect is present in the inner peripheral part, the outer peripheral part or the intermediate part prior to the calculation of the optimum recording power based on the OPC learning in the inner peripheral part, the outer peripheral and the intermediate part, wherein
the OPC address determining unit changes the position in a radial direction of the disc in the inner peripheral part, the position in a radial direction of the disc in the outer peripheral or the position in a radial direction of the disc in the intermediate part where the surface defect is detected, to a position where the surface defect is not present, when the defect detector defects the surface defect.
